(19) United States
(12) Patent Application Publication
(10) Pub. No.: US 2022/0081528 A1
(43) Pub. Date: Mar. 17, 2022

(54) Foam Thermoplastic Vulcanizate Pellet Compositions, Methods, and Articles Related Thereto

(71) Applicant: ExxonMobil Chemical Patents Inc., Baytown, TX (US)

(72) Inventors: Antonios K. Doufas, Houston, TX (US); Hang Dong, Shanghai (CN); Krishnan Anantha Narayana Iyer, Manvel, TX (US); Oscar O. Chung, Yuseong-gu (KR); Xin Chen, Shanghai (CN); Michael J. Goncy, Mont Belvieu, TX (US); John A. Bowers, Baytown, TX (US); Kathy B. Cabrera, Dayton, TX (US); Porter C. Shannon, Seabrook, TX (US); Christopher S. Breiner, Pasadena, TX (US)

(21) Appl. No.: 17/419,062

(22) PCT Filed: Jan. 13, 2020
(86) PCT No.: PCT/US2020/013274

§ 371 Date: Jun. 28, 2021

Related U.S. Application Data
(60) Provisional application No. 62/792,192, filed on Jan. 14, 2019.

(51) Int. Cl. C08J 9/32; C08J 9/00; C08J 9/16

(52) U.S. Cl. CPC C08J 9/32; C08J 9/0061; C08J 9/16; C08J 2203/22; C08J 2201/03; C08J 2323/12; C08J 2323/06; C08J 2300/26; C08J 2300/22; C08J 2323/16

(57) ABSTRACT

Foam pellets comprising a thermoplastic vulcanizate (TPV) and thermo-expandable microspheres, the foam pellet having a specific gravity of 0.2 to 1.0 and the TPV being composed of an at least partially vulcanized rubber component and a thermoplastic component. The foam pellets may be subsequently processed to form various foam articles without the need to include a foaming agent during processing.

### CROSS-REFERENCE TO RELATED APPLICATIONS

This application claims the priority benefit of Provisional Application No. 62/792,192, filed Jan. 14, 2019, the disclosure of which is incorporated herein by reference.

### FIELD

This application relates to foam thermoplastic vulcanizate pellet compositions, methods, and articles related thereto and, in particular, to foam thermoplastic vulcanizate pellet compositions comprising thermo-expandable microspheres for use in subsequently forming various foam articles.

### BACKGROUND

Thermoplastic elastomers (TPE) are both elastomeric and thermoplastic. They are distinguished from thermoset rubbers which are elastomeric but not thermoplastic due to the crosslinking or vulcanization of the rubber, and are distinguished from general thermoplastics which are generally stiff and hard, but not elastomeric.

Thermoplastic vulcanizates (TPVs) are a class of TPE in which cross-linked rubber forms a dispersed, particulate, elastomeric phase within a stiff thermoplastic phase such that TPE properties achieved. TPVs or TPV compositions are conventionally produced by dynamic vulcanization. Dynamic vulcanization is a process whereby a rubber component is cross-linked, also referred to as vulcanized, under intensive shear and mixing conditions within a blend of at least one non-vulcanizing thermoplastic polymer component at or above the melting point of the thermoplastic. Typically, the rubber component forms cross-linked, elastomeric particles dispersed uniformly in the thermoplastic. Dynamically vulcanized TPE consequently has a combination of both thermoplastic and elastic properties.

TPV may be provided in form of a raw material pellet. Such pellets may additionally include one or more pigments or additional additives, such as processing and/or dispersing aids. The components of the TPV and any additional additives are generally melt-blended or compounded in an extruder (e.g., a single- or twin-screw extruder) and pelletized to form the raw material TPV pellets. The pellets are manufactured and commercialized, and end-users may thereafter process the pellets to form end-use plastic articles.

For certain end-use articles, it is desirable that the processed TPV pellets be foamed, such as for use in forming a low-density article (e.g., a weather seal article for use in the automotive field or other industry). TPV pellets can be foamed by incorporating an endothermic or exothermic chemical or physical foaming agent blended with the TPV base pellet during formation of the desired foam article. That is, end-users may incorporate chemical or physical foaming agents during the process of forming the TPV pellet into a particular end-use plastic article. Such foaming during form article formation may require end-users to have specialized machinery, increase production costs, increase production time, and otherwise be cumbersome to an end-user.

### BRIEF DESCRIPTION OF THE DRAWINGS

This application relates to foam thermoplastic vulcanizate pellet compositions, methods, and articles related thereto and, in particular, to foam thermoplastic vulcanizate pellet compositions comprising thermo-expandable microspheres for use in subsequently forming various foam articles.

FIG. 1 shows an optical microscopy image of a cross-sectional area of a foam pellet formed according to one or more embodiments of the present disclosure.

FIG. 2 shows an optical microscopy image of a cross-sectional area of a foam tape formed according to one or more embodiments of the present disclosure and representing a foamed article formed according to one or more embodiments of the present disclosure.

FIG. 3 shows an optical microscopy image of a cross-sectional area of a foam pellet formed according to one or more embodiments of the present disclosure.

FIG. 4 shows an optical microscopy image of a cross-sectional area of a foam tape formed according to one or more embodiments of the present disclosure and representing a foamed article formed according to one or more embodiments of the present disclosure.

FIG. 5 shows an optical microscopy image of a cross-sectional area of a comparative foam tape formed by dry blending a thermoplastic vulcanizate and thermo-expandable microsphere and representing a foamed article formed without the use of the foam pellets described herein.

### DETAILED DESCRIPTION

This application relates to foam thermoplastic vulcanizate pellet compositions, methods, and articles related thereto and, in particular, to foam thermoplastic vulcanizate pellet compositions comprising thermo-expandable microspheres for use in subsequently forming various foam articles.

One or more illustrative embodiments incorporating the embodiments of the present disclosure are included and presented herein. Not all features of a physical implementation are necessarily described or shown in this application for the sake of clarity. It is understood that in the development of a physical embodiment incorporating the embodiments of the present disclosure, numerous implementation-specific decisions must be made to achieve the developer's goals, such as compliance with system-related, business-related, government-related, and other constraints, which vary by implementation and from time to time. While a developer's efforts might be time-consuming, such efforts would be, nevertheless, a routine undertaking for those of ordinary skill in the art and having benefit of this disclosure.

Unless otherwise indicated, all numbers expressing quantities of ingredients, properties such as physical properties, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present disclosure. At the very least, and not as an attempt to limit the application of the doctrine of equivalents to the scope of the claim, each numerical parameter should at least be construed in light of the number of reported significant digits and by applying ordinary rounding techniques. Where the term “less than about” or “more than about” is used herein, the quantity being modified includes said quantity, thereby encompassing values “equal to.” That is, “less than about 3.5%” includes the value 3.5%.

When numerical lower limits and numerical upper limits are listed herein, ranges from any lower limit to any upper limit are contemplated, whether or not explicitly listed.

While compositions and methods are described herein in terms of “comprising” various components or steps, the compositions and methods can also “consist essentially of” or “consist of” the various components and steps.

All priority documents, patents, publications, and patent applications, test procedures (such as ASTM methods), and other documents cited herein are fully incorporated by reference to the extent such disclosure is not inconsistent with this disclosure and for all jurisdictions in which such incorporation is permitted.

Various terms as used herein are defined below. To the extent a term used in a claim is not defined below, it should be given the broadest definition persons in the pertinent art have given that term as reflected in one or more printed publications or issued patents.

As used herein, the term “vulcanized,” and grammatical variants thereof, refers in general to the state of a composition after all or a portion of the composition (e.g., rubber) has been subjected to some degree or amount of vulcanization (crosslinking). Accordingly, the term encompasses both partial and total vulcanization (crosslinking). A preferred type of vulcanization is “dynamic vulcanization,” discussed below, which also produces a “vulcanizate.” In at least some embodiments described herein, the term vulcanized may refer to more than insubstantial vulcanization (e.g., curing or crosslinking) that results in a measurable change in pertinent properties, such as a change in the elastic recovery (e.g., compression set, tension set, and the like) or melt flow index (MFI) of the composition by 10% or more (according to any ASTM-1238 procedure). In at least that context, the term vulcanization encompasses any form of curing (e.g., cross-linking), both thermal and/or chemical, that can be utilized in dynamic vulcanization.

As used herein, the term “cure,” and grammatical variants thereof (e.g., curing), refers to both crosslinking reactions and the process(es) used to achieve cross-linking of polymer chains within an elastomer or elastomer composition. The term “cure” may be used interchangeably with the term “vulcanize,” and grammatical variants thereof.

The term “dynamic vulcanization,” and grammatical variants thereof, means vulcanization or curing of a curable rubber component blended with a thermoplastic component under conditions of shear at temperatures sufficient to plasticize the mixture. In at least one embodiment, the rubber component is simultaneously cross-linked and dispersed as micro-sized particles within the thermoplastic component. Depending on the degree of cure, the rubber component to thermoplastic component ratio, compatibility of the rubber component and thermoplastic component, the processing equipment type and the intensity of mixing (shear rate), other morphologies, such as co-continuous rubber phases in the plastic matrix, are possible.

As used herein, the term “partially vulcanized,” and grammatical variants thereof (e.g., “at least partially vulcanized”), with reference to a rubber component is one wherein more than 5 weight percent (wt. %) of the rubber component (e.g., crosslinkable rubber component) is extractable in boiling xylene, subsequent to vulcanization, preferably dynamic vulcanization (e.g., crosslinking of the rubber phase of the thermoplastic vulcanizate). For example, at least 5 wt. % and less than 20 wt. % or 30 wt. % or 50 wt. % of the rubber component can be extractable from the specimen of the thermoplastic vulcanizate in boiling xylene, encompassing any value and subset therebetween. The percentage of extractable rubber component can be determined by the technique set forth in U.S. Pat. No. 4,311,628, which is hereby incorporated by reference in its entirety.

As used herein, the term “vulcanizate,” and grammatical variants thereof, refers to a composition that includes at least one component (e.g., rubber) that has been at least partially vulcanized.

As used herein, the term “thermoplastic vulcanizate” (also referred to as thermoplastic vulcanizate composition or TPV), and grammatical variants thereof, refers to any material that includes a dispersed, at least partially vulcanized, rubber component and a thermoplastic resin component (e.g., a polyolefinic thermoplastic resin). A TPV material can further include additive oil, fillers, curing agents, other ingredients, other additives, or combinations thereof.

As used herein, the term “rubber component,” and grammatical variants thereof (e.g., simply “rubber”), for use in forming the TPV and foam pellets of the present disclosure may be any material that is considered by persons skilled in the art to be a “rubber” or, as used interchangeably herein, an “elastomer.” In some embodiments, the rubber component is preferably a cross linkable rubber (e.g., prior to vulcanization) or cross-linked rubber component (e.g., after vulcanization). For example, the rubber component may be any olefin-containing rubber including, but not limited to, ethylene-propylene copolymers (EPM), including particularly saturated compounds that can be vulcanized using free radical generators such as organic peroxides, as described in U.S. Pat. No. 5,177,147. Other rubber components may include, but are not limited to, EPDM rubber or EPDM-type rubber. For example, the EPDM-type rubber can be a terpolymer derived from the polymerization of at least two different monoolefin monomers having from 2 to 10 carbon atoms, or 2 to 4 carbon atoms, and at least one poly-unsaturated olefin having from 5 to 20 carbon atoms, each encompassing any value and subset therebetween. Additional examples of suitable rubber components are described herein below.

The rubber component may also be a butyl rubber. The term “butyl rubber,” and grammatical variants thereof, includes a polymer that predominantly includes repeat units from isobutylene (e.g., a polymer comprising at least 70 mole % (mol %) repeat units from isobutylene), but may also include several repeat units of a monomer that provides a site for crosslinking. Monomers providing sites for crosslinking may include, but are not limited to, a polyunsaturated monomer, such as a conjugated diene or divinylbenzene. In one or more embodiments, the butyl rubber polymer may be halogenated to further enhance reactivity in crosslinking, which are referred to herein as “halobutyl rubbers.”

Further, the rubber component may be homopolymers of conjugated dienes having from 4 to 8 carbon atoms and rubber copolymers having at least 50 wt. % repeat units from at least one conjugated diene having from 4 to 8 carbon atoms, each encompassing any value and subset therebetween.

The rubber component may also be synthetic rubber, which can be nonpolar or polar depending on the comonomers. Examples of synthetic rubbers may include, but are not limited to, synthetic polyisoprene, polybutadiene rubber, styrene-butadiene rubber, butadiene-acrylonitrile rubber, and the like. Amine-functionalized, carboxy-functionalized, or epoxy-functionalized synthetic rubbers can also be used, examples including, but not limited to, maleated EPDM.

Examples of specific rubber components for use in forming the foam pellets (and foam articles) of the present disclosure may include, but are not limited to, an ethylene-propylene rubber; an ethylene-propylene-diene rubber; a natural rubber; a butyl rubber; a halobutyl rubber; a halogenated rubber copolymer of p-alkystyrene and at least one isomonoolefin having 4 to 7 carbon atoms; a copolymer of isobutylene and divinyl-benzene; a rubber homopolymer of a conjugated diene having from 4 to 8 carbon atoms; a rubber copolymer having at least 50 weight percent repeat units from at least one conjugated diene having from 4 to 8 carbon atoms and a vinyl aromatic monomer having from 8 to 12 carbon atoms, or acrylonitrile monomer, or an alkyl substituted acrylonitrile monomer having from 3 to 8 carbon atoms, or an unsaturated carboxylic acid monomer, or an unsaturated anhydride of a dicarboxylic acid; or any combination thereof. The term “alkyl,” and grammatical variants thereof, refers to a paraffinic hydrocarbon group which may be derived from an alkane by removing one or more hydrogens, such as, a methyl group (CH₃), an ethyl group (CH₂CH₃), and the like.

As used herein, the term “thermoplastic component,” and grammatical variants thereof, of the TPV and foam pellets of the present disclosure refers to any material that is not a “rubber” (or an “elastomer”), and that is a polymer or polymer blend considered by persons skilled in the art as being thermoplastic in nature (e.g., a polymer that softens when exposed to heat and returns to its original condition when cooled to room temperature). The thermoplastic component may comprise one or more polyolefins, including polyolefin homopolymers and polyolefin copolymers. In one or more embodiments, the polyolefinic thermoplastic component comprises at least one of i) a polymer prepared from olefin monomers having 2 to 7 carbon atoms, encompassing any value and subset therebetween and/or ii) copolymer prepared from olefin monomers having 2 to 7 carbon atoms, encompassing any value and subset therebetween, with a (meth)acrylate or a vinyl acetate. Illustrative polyolefins may be prepared from monoolefin monomers including, but not limited to, ethylene, propylene, 1-butene, isobutylene, 1-pentene, 1-hexene, 1-octene, 3-methyl-1-pentene, 4-methyl-1-pentene, 5-methyl-1-hexene, mixtures thereof, copolymers thereof with (meth)acrylates and/or vinyl acetates, and any combination thereof. In one or more specific embodiments, the thermoplastic component comprises polyethylene, polypropylene, ethylene-propylene copolymer, and any combination thereof. The thermoplastic component may or may not be vulcanized or cross-linked.

In one or more embodiments, the thermoplastic component contains polypropylene. As used herein, the term “polypropylene.” and grammatical variants thereof, broadly means any polymer that is considered a “polypropylene” by persons skilled in the art (as reflected in at least one patent or publication), and includes, but is not limited to, homo, impact, and random polymers of propylene. In one or more embodiments, the thermoplastic component is or includes isotactic polypropylene. In some embodiments, the thermoplastic component contains one or more crystalline propylene homopolymers or copolymers of propylene having a melting temperature greater than 105° C. as measured by differential scanning calorimetry (DSC). Suitable copolymers of propylene may include, but are not limited to, terpolymers of propylene, impact copolymers of propylene, random polypropylene copolymers, and any combination thereof. Certain suitable comonomers have 2 carbon atoms, or from 4 to 12 carbon atoms, encompassing any value and subset therebetween. In some embodiments, the comonomer is ethylene. Thermoplastic components and methods for making the same are described in U.S. Pat. No. 6,342,565, which is incorporated herein by reference in its entirety.

As used herein and except as stated otherwise, the term “copolymer,” and grammatical variants thereof, refers to a polymer derived from two or more monomers (e.g., terpolymers, tetrapolymers, and the like).

As used herein, the terms “thermo-expandable microsphere” and “thermo-expandable microsphere foaming agent,” and grammatical variants thereof, refers to a foaming agent having a polymer shell (e.g., a thermoplastic shell) encapsulating a propellant. When heated, the thermo-expandable microspheres expand, such as up to about 80 times their original volume. Descriptions of suitable thermo-expandable microspheres are included in U.S. Pat. Nos. 6,582,633 and 3,615,972, WO 1999046320, and WO 1999043758, which are hereby incorporated by reference in their entirety. Examples of commercially available thermo-expandable microspheres include, for example, EXPANCEL™ products, available from AkzoNobel N.V, Amsterdam. Netherlands; and ADVANCELL™, available from Sekisui Chemical Co., Ltd., Osaka, Japan.

The thermo-expandable microspheres (also referred to herein simply as “microsphere(s)”) for use in forming the foam pellets according to the present disclosure act as a foaming agent, comprising a polymer shell encapsulating a propellant. In the microsphere, the polymer shell is generally a thermoplastic and may be made of a homo- or co-polymer of ethylenically unsaturated monomers, such as nitrile-containing monomer(s); the propellant is generally a liquid (e.g., a hydrocarbon) having a boiling temperature not higher than the softening temperature of the polymer shell. The expansion of the thermo-expandable microspheres is governed by physics; as the propellant is heated, the propellant evaporates and increases the intrinsic pressure, and at the same time, the shell softens due to exposure to the heat, thus causing the microsphere to expand. Generally, the microspheres may expand from about 2 to about 8 times their initial (non-heated) diameter or about 30 to about 80 times volume, and the thickness of polymer shell decreases to about 0.1 μm or less, each encompassing any value and subset therebetween. The factors determining the expandability of the microspheres may include, but are not limited to, the volatility of the encapsulated propellant, the gas permeability of the heated propellant, the viscoelasticity of the polymer shell, and the like.

Various monomers are suitable for preparation of the polymer shell of the thermo-expandable microspheres described herein and may include, but are not limited to, acrylonitrile, methacrylonitrile, α-haloacrylonitrile, α-ethoxyacrylonitrile, fumarc nitrile, an acrylic ester, and the like, and any combination thereof. In some embodiments, the polymer shell comprises polyacrylonitrile. The polymer shell generally has an expansion temperature (i.e., the glass transition temperature (Tg)) of from about 80° C. to about 200° C., depending on the composition of the polymer shell, encompassing any value and subset therebetween.

The liquids suitable for preparation of the propellant of the thermo-expandable microsphere for use in forming the foam pellets of the present disclosure usually have a boiling point lower than the softening temperature of the polymer shell at atmosphere pressure. Suitable liquids may include, but are not limited to, isobutene; 2,3-dimethylbutane; 2-methylpentane; 3-methylpentane; n-hexane; cyclohexane; heptane; isooctane; and the like; and any combination thereof.

In one or more embodiments, additives may be added to the foam pellets of the present disclosure, such as to aid in processing and manufacture of the foam pellets or to impart particular properties (e.g., stiffness, specific gravity, and the like). As used herein, the term “additive,” and grammatical variants thereof, includes any component of the foam pellets of the present disclosure except the rubber component, the thermoplastic component, and the thermo-expandable microsphere component. Examples of suitable additives may include, but are not limited to, additive oils, curing agents, particulate fillers, thermoplastic modifiers (e.g., elastomers/plastomers such as VISTAMAXX™ and EXACT™ polymers, available from ExxonMobil Chemical, Houston, Tex. or VERSIFY™ propylene based elastomer/plastomers, available from the Dow Chemical Company, Midland, Mich.), lubricants, antioxidants, antiblocking agents, stabilizers, anti-degradants, anti-static agents, waxes, foaming agents, pigments, processing aids, adhesives, tackifiers, plasticizers, wax, discontinuous fibers (such as world cellulose fibers), and any combination thereof.

As used herein, the term “additive oil,” and grammatical variants thereof, refers to an oil added to the foam pellet compositions of the present disclosure to at least enhance the processability and manufacturing of the foam pellets. The term “additive oil” herein encompasses both “process oils” and “extender oils.” For example, “additive oil” can include hydrocarbon oils, mineral oils, paraffin oils, or synthetic oils with or without and plasticizers, such as organic esters or synthetic plasticizers. In some embodiments, the additive oil and amount thereof is selected to have little or no impact on the thermo-expandable microspheres and, thus, no impact on the foam quality of the foam pellet or any foam article made therefrom.

As used herein, the term “curing agent,” and grammatical variants thereof (e.g., “cure agent”), refers to a compound that is used to cause a cure of a rubber or rubber composition. The term “curing agent” may be used interchangeably herein with the terms “cross-linking agent,” “curative,” and “vulcanizing agent.” Examples of curing agents may include, but are not limited to, a phenolic compound (e.g., resin), a peroxide, a metal oxide, a maleimide, a sulfur-based curative, a silicon-based curative, a silicon hydride-based (hydrosilylation) curative, a silane-based curative, a metal ligand complex, and the like, and any combination thereof.

As used herein, the term “particular filler,” and grammatical variants thereof, may be included in the foam pellets of the present disclosure to enhance various properties thereof, such as strength; toughness; resistance to tearing, abrasion and flex fatigue; increase durability; coloration (i.e., act as a pigment); elasticity; flexibility; and the like. Illustrative particulate fillers may include, but are not limited to, carbon black, clay, silica, titanium dioxide, calcium carbonate, colored pigments, and any combination thereof. The term “particular filler” may alternatively be referred to by one of skill in the art as a “reinforcing filler” or “reinforcing filler material.”

The particulate fillers for use in the forming the foam pellets of the present disclosure may be of any size and shape. Generally, the size of the particulate fillers (i.e., diameter) is in the range of about 0.0001 μm to about 10 μm, encompassing any value and subset therebetween, such as from a lower limit of about 0.0001 μm, 0.001 μm, 0.01 μm, 0.1 μm, 1 μm, 10 μm, 20 μm, 30 μm, 40 μm, or 50 μm to an upper limit of about 100 μm, 90 μm, 80 μm, 70 μm, 60 μm, or 50 μm, encompassing any value and subset therebetween.

As used herein, the term “accelerator,” and grammatical variants thereof refers to an additive that promotes acceleration of the cure process of a TPV composition (e.g., to increase the degree of vulcanization). Examples of accelerators include organic compounds, amines, guanidines, thioureas, thiazoles, thiurams, sulfenamides, sulfenimides, thiocarbamates, xanthates, and the like, and any combination thereof. Yet other accelerators include, but are not limited to, stannous chloride, stannous chloride anhydride, stannous chloride dehydrate, ferric chloride, and the like, and any combination thereof.

As used herein, the term “pphr” or “phr,” which may be used interchangeably, means parts per hundred dry rubber (i.e., rubber without any oil), and is a measure of components within a composition relative to the total weight of elastomer(s), based on 100 parts by weight of the elastomer(s). Measurement in “phr” is a measurement unit commonly known by those of skill in the art.

As used herein, the term “foam pellet,” and grammatical variants thereof, refers to a durable pellet structure having a specific gravity of less than 1.0, or about 0.1 to 1.0, and being composed of at least a TPV and thermo-expandable microspheres, in accordance with the embodiments of the present disclosure. As used herein, specific gravity and density (grams per cubic centimeter (g/cm³)) are considered equivalent within an average of about ±5%, and are accordingly considered interchangeably values (e.g., a density of 0.5 g/cm³ is equivalent to a specific gravity of about 0.5±0.025%). The expansion of the thermo-expandable microspheres does not define the foam pellets of the present disclosure, but merely its presence included therein; that is, the included thermo-expandable microspheres may be in an expanded state, an unexpanded state, or any combination and magnitude of expanded and unexpanded states. That is, “foam” is not exclusive to any particular expansion characteristic or quality of the thermo-expandable microspheres described herein (i.e., the term encompasses “foamed.” “foamable,” and “foaming”). The composition and details of the foam pellets of the present disclosure are described in more detail herein below.

As used herein, the term “upstream,” and grammatical variants thereof, refers to a relative term describing a location (and, accordingly, a time) along the length of an extruder (which may or may not have a reaction occurring there through) that is earlier than a given reference point, and accordingly closer to the beginning of the extrusion process. For example, if an additive oil is included in an extrusion process upstream of a curing agent, the additive oil is added at a location that is closer to the beginning of the extrusion process and before the addition of the curing agent. The converse is true, as used herein, of the term “downstream,” and grammatical variants thereof, referring to a relative term describing a location (and, accordingly, a time) along the length of an extruder that is later than a given reference point, and accordingly farther to the beginning of the extrusion process. For example, if an additive oil is included in an extrusion process downstream of a curing agent, the additive oil is added at a location that is farther from the beginning of the extrusion process and after the addition of the curing agent.

As used herein, the term “extruder,” and grammatical variants thereof, refers to a machine that extrudes (e.g., pushes and/or shapes) a material (e.g., the components of the foam pellets and/or foam articles of the present disclosure) through a die by any means (e.g., by force, mixing, shearing, and the like, and any combination thereof). As used herein, the general term “extruder” encompasses “reaction extruder,” such that an extruder described herein may be capable of allowing a particular reaction to occur during the extrusion process (e.g., dynamic vulcanization).

As used herein, the term “processing,” and grammatical variants thereof refers to any methodology for preparing the foam article of the present disclosure from a foam pellet. Examples of such processing methodology may include, but are not limited to extrusion (including co-extrusion and profile extrusion), injection molding, blow molding, compression molding, thermo-forming, elastic-welding, and the like. The term “processing” used herein may be used interchangeably with the term “manufacturing.”

As used herein, the term “foam article,” and grammatical variants thereof, refers to any industrial or useful article formed from the foam pellets of the present disclosure. Typically, these foam articles are used in applications for which it is desirable to have a low density and, accordingly, have a specific gravity of less than 0.9, and having expanded thermo-expandable microspheres incorporated therein. As described in greater detail herein below, advantageously, the manufacture or formation of the foam articles of the present disclosure can be achieved using standard equipment and without the need to introduce foaming agents during the manufacture or formation process because the foam pellets described herein already include incorporated (e.g., pre-loaded) thermo-expandable microspheres. During the formation of the foam article, such thermo-expandable microspheres in the foam pellet may be pre-expanded, partially pre-expanded, or expand during formation of the foam article, without departing from the scope of the present disclosure.

### Foam Pellet Composition

In some embodiments of the present disclosure, a foam composition is provided comprising a thermoplastic vulcanizate (TPV) and thermo-expandable microspheres, where the TPV is comprised of at least a partially vulcanized rubber component (e.g., ethylene-propylene-diene rubber, or any of those described herein, for instance) and a thermoplastic component (e.g., polyethylene, polypropylene, or a combination thereof; or any of those described herein, for instance). As provided above, the foam pellet includes already-present thermo-expandable microspheres and can accordingly be immediately transformed from its pellet configuration into a foam article, including at an end-users facility with standard equipment and reduced costs. Traditionally, any such thermo-expandable microspheres are included in a TPV composition during the extrusion or otherwise during the processing of a foam article, thereby requiring specialized equipment and careful process parameter controls including melt temperature, pressure, residence time, and the like. Such a controlled process is not typically available to many end-users and can result in increased material, time, and personnel costs, such as due to specialized equipment (e.g., very accurate feeding systems to incorporate the microspheres) and associated maintenance, specialized personnel, increased off-spec (or unusable) product and associated waste, and the like, to produce the desired final foam article. Moreover, the consistency of specific gravity of the foam article and physical properties thereof may not be acceptable due to deficient homogeneity of the microspheres in the bulk and surface of the TPV pellet.

Therefore, the foam pellets of the present disclosure offer an alternative by providing the foam pellets with included thermo-microspheres immediately present. The foam pellets described herein may have the thermo-expandable microspheres in a wholly expanded state, a wholly unexpanded state, or a partially expanded and partially unexpanded state, without departing from the scope of the present disclosure. For example, in some embodiments, the foam pellets described herein may comprise thermo-expandable microspheres where at least a portion of the thermo-expandable microspheres are unexpanded, or at least 30% are unexpanded, or at least 50% are unexpanded, or at least 70% are unexpanded, or more (i.e., up to 100% are unexpanded). Accordingly, in some embodiments, the foam pellet may have a specific gravity (SG) reflective of any one of those expansion states and may further foam (e.g., decrease specific gravity) upon formation of the foam pellet into one or more foam articles. For example, in some embodiments, the foam pellets have a specific gravity in the range of less than 1.0. In certain specific embodiments, the foam pellets may have a specific gravity in the range of 0.2 to 1.0, encompassing any value and subset therebetween, including a lower limit of 0.2, 0.3, 0.4, 0.5, and 0.6 to an upper limit of 1.0, 0.9, 0.8, 0.7, and 0.6, encompassing any value and subset therebetween. In some embodiments, the foam pellets have a specific gravity in the range of from 0.5 to 1.0, or from 0.5 to 0.95, or from 0.7 to 0.9, or from 0.6 to 0.96, or from 0.6 to 0.9, encompassing any value and subset therebetween.

The particular specific gravity of one or more foam pellets prepared in accordance with the embodiments of the present disclosure may be attributed to the specific methodology. As described in greater detail herein, a single-step or two-step process may be used in forming the foam pellets and the resultant specific gravity thereof varies depending on the selected method, and moreover on the various process parameters for each method. Additionally, the maintenance of the integrity of the thermo-expandable microspheres during manufacture of the foam pellets will influence specific gravity. In some embodiments, the thermo-expandable microspheres are in a wholly un-ruptured state and, accordingly, the full influence of the thermo-expandable microspheres, whether in an expanded state, an unexpanded state, or combined state thereof. In some instances, ruptured thermo-expandable microspheres can result in a foam pellet having a specific gravity that would otherwise be less if the thermo-expandable microspheres were not in a ruptured state or had less rupture (for current expansion or future expansion, such as during the formation of a foam article). Accordingly, where foam articles having a relatively low specific gravity are desired, as described herein, the foam pellets of the present disclosure comprise thermo-expandable microspheres in which greater than at least 50% of the thermo-expandable microspheres have an un-ruptured shell, encompassing any value and subset therebetween, including a lower limit of 50%, 55%, 60%, 65%, 70%, and 75% to an upper limit of 100%, 95%, 90%, 85%, 80%, and 75% of the included thermo-expandable microspheres forming the foam pellet.

The foam pellets of the present disclosure generally have a pellet count (e.g., representative of a measure of their size), expressed in pellets/gram (ppg), of 10 to 200, encompassing any value and subset therebetween, such as 15 to 85, or such as 20 to 70. The ppg is reported by weighing three (3) 1 gram samples of foam pellets, counting the number of pellets within each 1 gram sample, and averaging the three (3) counts.

The pellet size may be determined via optical microscopy and associated software, such as by using IMAGE-PRO® PLUS software (e.g., version 7.0), available from Media Cybernetics, Inc. in Rockville, Md. The software may be used to threshold pixels based on color value of the foam pellets described herein. In the case of dark and/or black foam pellets, all pixels with less than a specified arbitrary color value, for example 80, are set to a new binary arbitrary value. Therefore, all pixels with a value of 80 or less are set to equal one (1) and all pixels with a value greater than 80 are set to equal zero (0) to form a binary image. The continuous pixels with a value of one (1) are counted along x and y dimensions. The number of pixels are then converted to a unit of measure, such as millimeters (mm), as determined by a scaling factor which is found by taking a picture of a ruler and setting the scaling factor, for example 1024 pixels=10 mm.

In some embodiments, when determining the foam pellet size of the present disclosure via optical microscopy and associated software (using IMAGE-PRO PLUS v. 7.0), the “average length of diameters” used was the length measured at 2 degree intervals and passing through the object (the foam pellet) centroid; the “characteristic length” was the longest dimension of the object; the “characteristic width” was the shortest dimension of the object; “area” or “A” is the area of the object using the number of pixels converted to square mm (mm²) using the scaling of x pixels=y mm using a ruler; the “characteristic or equivalent diameter” or “D_{eq}” is defined herein as the square root of 4× the A dividing by π=3.14159 according to Equation A:

D_{eq}=(4*A/π)^{1/2}

The characteristic or equivalent diameter (D_{eq}) applies for any shape of foam pellet described herein including, but not limited to, circular-shaped, spherical-shaped, ovoid-shaped, rectangular-shaped, square-shaped, cube-shaped, polygonal-shaped, irregular-shaped, and the like, and any combination thereof.

The foam pellets can have an average characteristic length from about 0.5 mm to about 10 mm and an average characteristic width from about 0.5 mm to about 10 mm. The foam pellets can have an average characteristic or equivalent diameter (D_{eq}) from about 0.5 mm to about 10 mm, encompassing any value and subset therebetween, preferably from about 1 to about 8 mm, more preferably from about 2 to about 7 mm, more preferably from about 3 to about 6 mm. The foam pellets can have an average area from about 0.1 mm² to about 80 mm², encompassing any value and subset therebetween, preferably from about 0.8 mm² to about 50 mm², preferably from about 3 mm² to about 40 mm², preferably from about 7 mm² to about 30 mm².

As previously discussed, the foam pellets of the present disclosure are comprised of a TPV and thermo-expandable microspheres. The TPV includes an at least partially vulcanized rubber component and a thermoplastic component, as described herein. In one or more embodiments, the at least partially vulcanized rubber component may be composed of one or more of the applicable substances described hereinabove and may be present in an amount of from 10% to 90% by weight of the total weight of the TPV (that is, the combined rubber component and thermoplastic component, excluding any additional additives and the thermo-expandable microspheres), encompassing any value and subset there between, such as from a lower limit of 15% to an upper limit of 75%, or in the range of 20% to 50%, encompassing any value and subset therebetween. In one or more embodiments, the thermoplastic component may be composed of one or more of the applicable substances described hereinabove and may be present in an amount of from 10% to 90% by weight of the total weight of the TPV, encompassing any value and subset therebetween, such as from a lower limit of 25% to an upper limit of 85%, or in the range of 50% to 70% by weight of the total weight of the TPV, encompassing any value and subset therebetween.

In some embodiments, the TPV of the present disclosure may have a melt temperature (i.e., the temperature at which the thermoplastic vulcanizate components change state from solid to liquid at atmospheric pressure, regardless of the presence of the thermo-expandable microspheres) in the range of from 100° C. to 300° C., encompassing any value and subset therebetween, such as from 160° C. to 240° C., or 170° C. to 200° C., encompassing any value and subset therebetween. The TPV may have a Shore A hardness as determined by ISO868:2003 in the range of from 25 to 95, encompassing any value and subset therebetween, such as from 35 to 90, or from 65 to 85, or from 70 to 90, encompassing a value and subset therebetween. The TPV may have a Shore D hardness as determined by ISO868:2003 in the range of from 20 to 60, encompassing any value and subset therebetween, such as from 30 to 50, or from 40 to 50, encompassing any value and subset therebetween.

The thermo-expandable microspheres included in the foam pellets of the present disclosure, regardless of the methodology employed in their manufacture, may be present in an amount of from 0.5% to 10% by weight of the total weight of the TPV (i.e., the TPV and any additional additives), encompassing any value and subset therebetween, such as from a lower limit of 0.5%, 1%, 2%, 3%, 4%, and 5% to an upper limit of 10%, 9%, 8%, 7%, 6%, and 5%, or in the range of 0.7% to 5%, or 1% to 4%, or 0.85% to 4%, or 1.5% to 3% by weight of the total weight of the TPV, encompassing any value and subset therebetween. In some embodiments, the thermo-expandable microspheres are present in the foam pellets of the present disclosure in an amount of greater than 0.8% by weight of the total weight of the TPV, including up to 10%, encompassing any value and subset therebetween.

When a thermo-expandable microsphere of the present disclosure is heated, it begins to expand at a certain temperature. The temperature at which the expansion starts is called the “minimum expansion temperature” or “Tstart,” while the temperature at which expansion is complete (i.e., the maximum expansion) is called the “maximum expansion temperature” or “Tmax.” The Tstart and Tmax can be measured by thermomechanical analysis (TMA) of the thermal expansion quality of the microsphere. Examples of thermo-expandable microspheres for use in forming the foam pellets of the present disclosure may have a Tstart of equal to or greater than 100° C., or in some instances in the range of equal to or greater than 100° C. to equal to or less than 180° C., or in some instances in the range of equal to or greater than 150° C. and equal to or less than 175° C., encompassing any value and subset therebetween. Examples of thermo-expandable microspheres for use in forming the foam pellets of the present disclosure may have a Tmax of equal to or less than about 300° C., or in the range of equal to or less than 300° C. to equal to or greater than 180° C., or in the range of equal to less than 250° C. to equal or greater than 185° C. or in the range of equal to less than 230° C. and equal to or greater than 190° C., encompassing any value and subset therebetween. In some embodiments, the range of Tstart to Tmax of suitable thermo-expandable microspheres may be about 100° C. to about 300° C., encompassing any value and subset therebetween. In some embodiments, extruder temperatures may be less than the Tmax of the thermo-expandable microspheres downstream of introducing the thermo-expandable microspheres into the extruder (regardless of type of extruder or method used herein), and the thermo-expandable microspheres may have a Tmax of greater than 110° C., or greater than 150° C.

The thermo-expandable microspheres suitable for forming the foam pellets of the present disclosure before expansion may have various average particle sizes. In some embodiments, the particle size of the microspheres before expansion may range from 1 μm to 500 μm, encompassing any value and subset therebetween, such as from a lower 1 μm, 50 μm, 100 μm, 150 μm, 200 μm, and 250 μm to an upper limit of 500 μm, 450 μm, 400 μm, 350 μm, 300 μm, and 250 μm, encompassing any value and subset therebetween. In some embodiments, the particle size of the microspheres before expansion may range from 2 μm to 300 μm, or from 4 μm to 100 μm, or from 5 μm to 50 μm, or from 15 μm to 40 μm, or from 20 μm to 30 μm, encompassing any value and subset therebetween. The average particle size of the microspheres after expansion may be in the range of from 2 to 10 times their initial (non-heated) size, such as in the range of from 2 μm to 4000 μm, encompassing any value and subset therebetween. In some embodiments, the average particle size of the microspheres after expansion is greater than 20 μm, greater than 50 μm, greater than 80 μm, greater than 100 μm, greater than 120 μm, greater than 150 μm, or greater than 180 μm, encompassing any value and subset therebetween. Selection of a particular sized microsphere for use in the foam pellets may be based on a number of factors, such as cost, surface appearance, and the final properties of the foam itself (e.g., foam quality) of the foam pellet and/or a particular foam article. For example, if the microspheres are too small, a greater microsphere amount may be required to achieve the desired properties, which may increase cost. Alternatively, selection of too large microspheres may alter surface appearance compared to the same density of microspheres having relatively smaller sizes. In some embodiments, a preferred size of the microspheres after expansion is greater than or equal to 10 μm and less than or equal to 200 μm, or greater than or equal to 20 μm and less than or equal to 150 μm, encompassing any value and subset therebetween.

The thermo-expandable microspheres may be included in the foam pellets of the present disclosure neat (i.e., unaltered or un-mixed with other ingredients, which may be in solid or molten form) or otherwise in the form of a slurry. The thermo-expandable microspheres may be introduced as a slurry in which the thermo-expandable microspheres are dispersed in an oil (which may be referred to as “dust in oil”). This dispersion may be due to ease of storage, ease of processability in forming the foam pellet, or for other practical purposes. Typically, slurried thermo-expandable microspheres will be dispersed in oil in a ratio of 5:95 to 40:60, and preferably a ratio of 10:90 to 20:80, encompassing any value and subset therebetween, of thermo-plastic expandable microspheres to oil.

The particular oil may be any oil that is described herein as an additive oil, without departing from the scope of the present disclosure. The presence of the thermo-expandable microspheres in a slurry form does not influence their concentration, size, or expansion in the foam pellet as described herein. Examples of oils used to make the slurry of the expandable microspheres and/or for use as an additive oil may include, but are not limited to, a mineral oil, a synthetic oil, and any combination thereof. Mineral oils may include, for example, aromatic oils, naphthenic oils, paraffinic oils, isoparaffinic oils, synthetic oils, and the like, and any combination thereof. In some embodiments, the mineral oils may be treated or untreated. Examples of suitable commercially available oils for use making the slurried thermo-expandable microspheres and/or for use as an additive oil described herein may include, but are not limited to, SUNPAR™ paraffinic oils, available from Sun Chemical, Parsippany-Troy Hills, N.J.; PARALUX™ paraffinic oils, available from Chevron Corporation. San Ramon, Calif.; and PARAMOUNT™ paraffinic oils, available from Chevron Corporation, San Ramon, Calif. Other oils that may be used include, but are not limited to, hydrocarbon oils and plasticizers, such as organic esters and synthetic plasticizers. Some suitable oils are derived from petroleum fractions, and have particular ASTM designations depending on whether they fall into the class of paraffinic, naphthenic, or aromatic oils. Other types of suitable oils include, but are not limited to, alpha olefinic synthetic oils, such as liquid polybutylene. Suitable oils other than petroleum-based oils may also be used, such as oils derived from coal tar, pine tar, and the like, as well as synthetic oils (e.g., polyolefin materials).

Examples of oils additionally include base stocks. According to the American Petroleum Institute (API) classifications, base stocks are categorized in five groups based on their saturated hydrocarbon content, sulfur level, and viscosity index. Lube base stocks are typically produced in large scale from non-renewable petroleum sources. Group I, II, and III base stocks are all derived from crude oil via extensive processing, such as solvent extraction, solvent or catalytic dewaxing, hydroisomerization, hydrocracking and isodewaxing, and/or isodewaxing and hydrofinishing. Group III base stocks can also be produced from synthetic hydrocarbon liquids obtained from natural gas, coal, or other fossil resources; Group IV base stocks are polyalphaolefins (PAOs), and are produced by oligomerization of alpha olefins, such as 1-decene. Group V base stocks include all base stocks that do not belong to Groups I-IV, such as naphthenics, polyalkylene glycols (PAG), and esters.

In some embodiments, synthetic oils suitable for use in forming the slurries and/or for use as an additive oil described herein may include, but are not limited to, polymers and oligomers of butenes, including isobutene, 1-butene, 2-butene, butadiene, and the like, and any combination thereof. In some embodiments, these oligomers may be characterized by a number average molecular weight (Mn) of from about 300 grams per mole (g/mol) to about 9,000 g/mol, or about 700 g/mol to about 1,300 g/mol, encompassing any value and subset therebetween. In some embodiments, these oligomers include isobutenyl mer units. Exemplary synthetic oils may include, but are not limited to, polyisobutylene, poly(isobutylene-co-butene), polylinear α-olefins, poly-branched α-olefins, hydrogenated polyalphaolefins, and the like, and any combination thereof. In some embodiments, the synthetic oils may include synthetic polymers or copolymers having a viscosity of about 20 centipoise (cP) or more, such as about 100 cP or more, or about 190 cP or more, encompassing any value and subset therebetween, where the viscosity is measured by a Brookfield viscometer according to ASTM D-4402 at 38° C. In these or other embodiments, the viscosity of these oils can be about 4,000 cP or less, such as about 1.000 cP or less, encompassing any value and subset therebetween.

Examples of suitable commercially available synthetic oils may include, but are not limited to, SOLTEX™ polybutenes, available from Soltex, Inc., Houston, Tex.; INDOPOL™ polybutenes, available from Ineos, League City, Tex.; SPECTRASYN™ white synthetic oils, available from ExxonMobil, Houston, Tex. (formerly SHF Fluids); ELEVAST™ hydrocarbon fluids, available from ExxonMobil, Houston, Tex.; RISELLA X™ white oils produced based on gas to liquids technology, available from Shell Global, The Hague, Netherlands (e.g., RISELLA™ X 415/420/430); PRIMOL™ white oils, available from ExxonMobil, Houston, Tex. (e.g., PRIMOL™ 352/382/542); MARCOL™ white oils, available from ExxonMobil, Houston, Tex. (e.g., MARCOL™ 82/52); and DRAKEOL® white oils, available from Penreco, Karns City, Pa. (e.g., DRAKEOL® 34). Oils described in U.S. Pat. No. 5,936,028 may also be employed, the entirety of which is incorporated herein by reference in its entirety. Any combinations of the aforementioned oils may additionally be used, without departing from the scope of the present disclosure.

Accordingly, the oil used as an additive oil may be the same or different than the oil used in forming a slurry of thermo-expandable microspheres (when applicable), without departing form the scope of the present disclosure. In some embodiments, it may be preferred that the selected oil is the same for use as the additive oil and for forming the slurry of thermo-expandable microspheres to minimize any manufacturing adjustments necessary to account for any particular physical or chemical differences between the oils (e.g., temperature, shear, and the like).

The foam pellets of the present disclosure may further comprise one or more additives in addition to the TPV and thermo-expandable microspheres. These additives may be used to aid in processability of the foam pellets and/or to impart certain chemical, physical, or mechanical properties.

When used in the preparation of the foam pellets described herein, the additive oil may be any oil suitable for aiding in the processing of the components of and manufacture of the foam pellets, such as those described above, and may be present in an amount sufficient to impart the desired properties and/or processability to the foam pellets and components thereof. For example, the additive oil may soften the rubber component or provide lubrication, among other things, to facilitate mixing operations, reduce compounding time, and/or modify the physical properties of the final foam pellet composition and foam articles made therefrom. In some embodiments, the additive oil may be present in the foam pellet compositions of the present disclosure in an amount of from 5 phr to 300 phr, encompassing any value and subset therebetween, such as from a lower limit of 10 phr to an upper limit of 50 phr, or from a lower limit of 15 phr to an upper limit of 35 phr, encompassing any value and subset therebetween. The quantity of additive oil may depend on the properties desired, with an upper limit that may depend on the compatibility of the particular oil and blend ingredients; this limit can be exceeded when excessive exuding of additive oil (e.g., extender oil) occurs. The amount of additive oil can depend, at least in part, upon the type of rubber. High viscosity rubbers are more highly oil extendable. When ester plasticizers are employed, the ester plasticizers are generally used in amounts of about 250 phr or less, such as about 175 phr, encompassing any value and subset therebetween.

A particulate filler may be used in the preparation of the foam pellets of the present disclosure, and may include one or more particulate fillers (e.g., any one or more of those specifically described herein) and in any amount to impart the desired physical and/or mechanical properties thereto. In some embodiments, the particulate filler material may be present in the foam pellet compositions of the present disclosure an amount of from 1 phr to 250 phr, encompassing any value and subset therebetween, such as from a lower limit of 10 phr to an upper limit of 250 phr, or from 10 phr to 150 phr, or from 40 phr to 70 phr, encompassing any value and subset therebetween. Examples of fillers that can be added in the thermoplastic vulcanizate composition may include, but are not limited to, carbon black, clay, talc, calcium carbonate, mica, wood flour, and the like, and any combination thereof.

In some embodiments, a curing agent may be used to facilitate the curing of the rubber component of the TPV in the foam pellet, and may be any one or more rubber components suitable for forming the foam pellets as defined herein (including those specifically described herein). As noted above, the thermoplastic vulcanizates prepared according to the present disclosure may be dynamically vulcanized by a variety of curative systems including, for example, employing a phenolic resin cure system, a peroxide cure system, a maleimide cure system, a silicon-based cure system (including hydrosilylation cure system and/or a silane-based system, such as a silane grafting followed by moisture cure), a sulfur cure system, and the like, and any combination thereof.

Useful phenolic cure systems are disclosed in U.S. Pat. Nos. 2,972,600; 3,287,440; 6,437,030; and 5,952,425, the entireties of which are incorporated herein by reference.

In some embodiments, phenolic resin curatives may include resole resins, which may be made by the condensation of alkyl substituted phenols or unsubstituted phenols with aldehydes, such as formaldehydes, in an alkaline medium or by condensation of bi-functional phenoldialcohols. The alkyl substituents of the alkyl substituted phenols may contain between about 1 and about 10 carbon atoms, such as dimethylolphenols or phenolic resins, substituted in para-positions with alkyl groups containing between about 1 and about 10 carbon atoms. In some embodiments, a blend of octylphenol-formaldehyde and nonylphenol-formaldehyde resins may be employed. The blend may include from about 25 weight % (wt. %) to about 40 wt. % octylphenol-formaldehyde and from about 75 wt. % to about 60 wt. % nonylphenol-formaldehyde, such as from about 30 wt. % to about 35 wt. % octylphenol-formaldehyde and from about 70 wt. % to about 65 wt. % nonylphenol-formaldehyde, encompassing any value and subset therebetween. In some embodiments, the blend may include about 33 wt. % octylphenol-formaldehyde and about 67 wt. % nonylphenol-formaldehyde resin, where each of the octylphenol-formaldehyde and nonylphenol-formaldehyde include methylol groups. This blend may be solubilized in paraffinic oil at about 30% solids without phase separation.

Useful commercially available phenolic resins may include, but are not limited to, SP-1044 and SP-1045 alkylphenol-formaldehyde resins, available from SI Group, Inc., Schenectady, N.Y.

An example of a suitable phenolic resin curative may include that defined according to the general formula. Formula A:

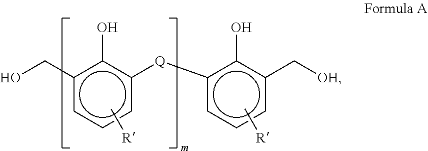

where Q is a divalent radical selected from the group consisting of —CH₂—, —CH₂—O—CH₂—, m is zero or a positive integer from 1 to 20, and R′ is an organic group. In some embodiments, Q is the divalent radical —CH₂—O—CH₂—, m is zero or a positive integer from 1 to 10, and R′ is an organic group having less than 20 carbon atoms. In other embodiments, m is zero or a positive integer from 1 to 10 and R′ is an organic radical having between 4 and 12 carbon atoms.

The particular amount of curing agent may be dependent on the various components of the foam pellet selected, the manufacturing conditions, and the like, and any combination thereof. In some embodiments, the curing agent may be present in the foam pellet compositions of the present disclosure in an amount of from 0.5 to 30 phr, encompassing any value and subset therebetween, such as from a lower limit of 1 phr to an upper limit of 20 phr, or a lower limit of 2 phr and an upper limit of 6 phr, encompassing any value and subset therebetween.

In some embodiments, an accelerator may be present in the foam pellets of the present disclosure for use in accelerating curing, and may be used in conjunction with one or more curing agents. The accelerator may be any accelerator capable of accelerating curing of the components of the foam pellets described herein (including those specifically described herein) and in the amount to impart the desired magnitude of acceleration. For phenolic based curatives, for example, the accelerator may be a halogen source compound, such as stannous chloride. In addition, a metal oxide or reducing compound such as zinc oxide may be used in combination with the phenolic resin curative and the stannous chloride accelerator. The metal oxide acts as a moderator for the curing reaction, as an acid scavenger, and improves heat stabilization.

In some embodiments, the accelerator may be present in the foam pellet compositions of the present disclosure in an amount of from 0.5 to 5 phr, encompassing any value and subset therebetween, such as from a lower limit of 0.8 phr to an upper limit of 2 phr, or from a lower limit of 1 phr to an upper limit of 1.5 phr, encompassing any value and subset therebetween. In conjunction with the accelerator, a metal oxide (e.g., zinc oxide, magnesium oxide, and the like) may additionally be used, where the metal oxide is present from about 0.1 phr to about 6 phr, such as from about 1 phr to about 5 phr, or from about 1 phr to about 2.0 phr, encompassing any value and subset therebetween.

In some embodiments, one or more thermoplastic modifiers (e.g., elastomers such as propylene based elastomers/plastomers including, but not limited to, VISTAMAXX™ olefinic elastomers, available from ExxonMobil Chemical. Houston, Tex. or VERSIFY™ olefinic elastomers, available from the Dow Chemical Company, Midland, Mich.) may be included in the foam pellet compositions of the present disclosure to improve performance (e.g., improved elongation to break) and/or processability of the foam pellets. It is to be noted, however, that the inclusion of such thermoplastic modifiers is not necessary to achieve the foam pellet characteristics described herein. When included, the thermoplastic modifiers may be present in the foam pellet compositions of the present disclosure in an amount of from 0.5 to 100 phr, encompassing any value and subset therebetween, such as from a lower limit of 5 phr to an upper limit of 70 phr, or a lower limit of 20 to an upper limit of 50, encompassing any value and subset therebetween.

### Manufacturing the Foam Pellets

The embodiments of the present disclosure provide one or more methods for the preparation of the foam pellets described above. The preparation methods described herein are distinguished from various traditional foaming methods because the foam pellet as defined herein are not traditionally prepared for subsequent use in forming a foam article. That is, traditionally, any foaming agent (e.g., thermo-expandable microspheres) is included with a TPV composition during the manufacture of a foam article. Accordingly, typically a TPV pellet without foaming agent is combined with a foaming agent during the process of manufacturing an end-use article (e.g., a foam article). Differently, the foam pellets of the present disclosure are in pellet form and have pre-included thermo-expandable microspheres, thereby allowing direct extrusion (or other processing) of the foam pellet to form a foam article. Moreover, the foam pellets of the present disclosure and prepared according to one or more of the embodiments described herein exhibit a high degree of microsphere dispersion within the TPV pellet composition. Without being bound by theory, it is believed that the high degree of microsphere dispersion within the foam pellet compositions described herein results in a very consistent specific gravity (SG) or density of the pellet and resultant foam article (also referred to herein as foam part or simply part), as defined with a standard deviation of the SG across the foam article (e.g., tape, weather seal, and the like) of less than or equal to 0.05, or preferably less than or equal to 0.01, or preferably less than or equal to 0.007, including a SG of zero (0).

The processes (e.g., single-step and two-step) described herein result in a foam pellet that can be prepared before, during, or after dynamic vulcanization, and using temperatures and equipment that are conducive to increased overall production rates (e.g., no need for a kneading step, which can be cost prohibitive and reduce production rates due to batch operation). In particular, the ability to prepare the foam pellet, having the qualities described herein, during dynamic vulcanization and incorporating the thermo-expandable microspheres in the foam pellet may reduce overall costs, increase production rates, improve resultant foam article performance/quality/consistency, and provide an alternative to certain multi-step traditional operations.

In some embodiments, the methods described herein provide for preparing the foam pellet of the present disclosure comprising a TPV composition (e.g., PP/EPDM/oil/filler/curative, as described in greater detail below) and thermo-expandable microspheres allow use of an efficient, continuous extruder process; thereafter, the foam pellets can be subsequently processed in any thermoplastic processing equipment (e.g., standard equipment) to produce a foam article. The standard thermoplastic processing equipment may be, as non-limiting examples, a weather seal extruder, a combination of weather seal extruders (multi-layer co-extrusion), an injection molder, and the like. The resultant foam article, and as described in greater detail herein, may exhibit desirable mechanical properties and may be prepared without the complexity, for example, of a converter for making the final foam article (e.g., weather seal) and thereafter having to feed the thermo-expandable microspheres into an extruder, which could result in quality control issues during production and inconsistency in the article performance. In some embodiments, the foam articles exhibit desirable mechanical properties, including low specific gravity (e.g., less than 0.97, or less than 0.9 or less than 0.80, or less than 0.7) with desirable specific gravity consistency, control, and reproducibility (e.g., standard deviation of specific gravity of less than 0.05), and a stable, closed cell structure (e.g., greater than at least 50% closed cells).

### Single-Step Manufacturing of the Foam Pellets

As described in greater detail in the Examples, the foam pellets of the present disclosure may be formed in a single-step (i.e., one-step) process. In some embodiments, the single-step process of the present disclosure produces a foam pellet by introducing a rubber component to an extruder, introducing a thermoplastic component to the extruder, introducing a curing agent to the extruder either upstream, downstream, or simultaneously with thermo-expandable microspheres. The combined components are dynamically vulcanized to at least partially vulcanize the rubber component and to form a blend comprising TPV (i.e., the at least partially vulcanized rubber component and the thermoplastic component) and the thermo-expandable microspheres. Alternatively, the rubber component and the thermoplastic component (and any additives) are dynamically vulcanized prior to introduction of the thermo-expandable microspheres. The blend (i.e., after extrusion from the extruder die) is then pelletized (e.g., in series by use of a underwater pelletizer or separately after extrusion, such as by a strand cut pelletizer) to form the foam pellets of the present disclosure. The extruder may be, for example, a twin screw extruder or a single screw extruder. Moreover, in one or any embodiments, the extruder may further comprise a melt pump, such as a HENSCHEL™ melt pump, supplied by Henschel GmbH, Kassel. Germany. The palletization may be achieved using any method known to those of skill in the art, including manual palletization or use of a pelletizing unit (e.g., a strand cut pelletizer or an underwater pelletizer).

In some embodiments, one or more additives is introduced at one or more times (or locations) during the single-step process. That is, an additive may be added upstream, downstream, or simultaneously with the various components of the blend that is pelletized to form the foam pellets. In some embodiments, one or more additives are added to the extruder in the single-step manufacturing process upstream of the curing agent (and, optionally, accelerator) and/or downstream the curing agent (and, optionally, accelerator). For example, in some embodiments an additive of either or both of an additive oil and a particulate filler are introduced into the extruder upstream of the curing agent (and, optionally, accelerator). In some embodiments, two introductions of an additive oil into the extruder occur upstream of the curing agent (and, optionally, accelerator), such as a first “pill” or “bolus” type introduction of additive oil (which may be with or without additional additives, such as a particulate filler) followed by a second pill type introduction of another (same or different) additive oil, both introductions being upstream of the curing agent (and, optionally, accelerator). The addition of the second additive oil, for example, may be more or less than the first additive oil and may be used, for instance, to further enhance processability of one or more components of the foam pellet (e.g., the rubber component, the thermoplastic component, and/or the thermo-expandable microspheres, if then present).

In some embodiments, additional additive oil is introduced into the extruder downstream of the curing agent, which may be a “post-cure” additive oil. This additive oil may be introduced in order to further the processability of the foam pellet during dynamic vulcanization of the rubber component in the presence of the thermo-expandable microspheres, as well as improve the processability of the foam pellet during fabrication to make a foam article (e.g., weather seal), for example.

As provided above, the thermo-expandable microspheres may be added upstream, downstream, or simultaneously with the curing agent system, and, thus, may be included in the composition prior to, during, or after the dynamic vulcanization step in the single-step method for forming the foam pellets described herein. Accordingly, the single-step method of forming the foam pellets of the present disclosure does not require additional or different processing steps for incorporating the thermo-expandable microspheres, although offers the flexibility of permitting introduction of the thermo-expandable microspheres after the dynamic vulcanization step in a single processing equipment (extruder), where processing conditions or other factors warrant. In some embodiments, adding the thermo-expandable microspheres after the dynamic vulcanization step maybe preferred, since if the microspheres are added before or during vulcanization, they may interfere with the curing reaction or collapse due to the high shear forces during vulcanization.

As described above, the thermo-expandable microspheres may be introduced into the extruder in their solid form, a molten form, or in a slurry dispersed in oil. In some embodiments, when included in solid or molten form, the thermo-expandable microspheres may be introduced using a side feeder (e.g., a crammer feeder). A “crammer feeder” is generally a device fitted to an inlet port of an extruder that compounds materials and propels them into the feed section of the extruder, including before or after complete melting (plasticization) of the main feed of the extruder. In some embodiments, when the thermo-expandable microspheres are introduced to the extruder in slurry form, they may be introduced thereto by injection. The term “injection” refers to the introduction of a liquid such as oil or oil slurry under pressure into an extruder at a certain location along the screw.

In one or any embodiments, the single-step process may be used to manufacture foam pellets having thermo-expandable microspheres incorporated therein with a specific gravity of 0.2 to 1.0 (i.e., the thermo-expandable microspheres may be expanded, unexpanded, or partially expanded). In some instances, the process may utilize a continuous twin screw extruder process including the occurrence of dynamic vulcanization and incorporation of the thermo-expandable microspheres by injecting a slurry of the microspheres in oil or by feeding as a masterbatch (e.g., dry, unexpanded, but which may be mixed with a polymer carrier, such as a thermoplastic resin (e.g., EVA), another TPV (different than the foam pellet TPV), and/or a thermoplastic blend) of microspheres using, for example, a crammer feeder (e.g., a side crammer feeder) or they may be fed directly in the extruder hopper. Any combination of such introduction may be used, without departing from the scope of the present disclosure, such as if multiple types of thermo-expandable microspheres are used, or to achieve certain concentrations, to achieve certain qualities (e.g., homogeneous melt blending), and the like. In some embodiments, some preferred methods for introducing the thermo-expandable microspheres in the single-step process to make foam pellets described herein may include introduction via injection of a microsphere oil slurry or introduction with a side crammer feeder in solid form after completion of the dynamic vulcanization process along the screw.

Any TPV system may be used in accordance with the single-step methodology, but may preferably be a polypropylene/EPDM based system, as described above. That is, the rubber component may preferably be an ethylene-propylene-diene rubber and the thermoplastic component may preferably be polyethylene, polypropylene, or a combination thereof. During formation of the foam pellet according to the single-step method, the thermo-expandable microspheres may preferably be introduced into the extruder downstream of where dynamic vulcanization occurs. However, introduction of the thermo-expandable microspheres before or in the zones of dynamic vulcanization may beneficially be performed provided that the microspheres do not interfere with the vulcanization (curing) process and they are selected to have mechanical properties that withstand breaking or rupture under the necessary dynamic vulcanization conditions (e.g., temperature and shear) for the particular formulation.

Generally, it may not be desirable to use a melt pump as part of the single-step method for forming the foam pellets of the present disclosure, although one may be used, without departing from the scope of the present disclosure. In such cases where a melt pump is used in accordance with the embodiments of the present disclosure, the melt pump suction pressure is preferably higher than 50 pounds per square inch (psi), more preferably higher than 100 psi, more preferably higher than 200 psi. Indeed, provided that the thermo-microspheres withstand breaking or rupture under the conditions of the melt pump, one may be used, such as to increase throughput.

In some embodiments, and in provided in greater detail above and in the Examples below, for use in the single-step method of the present disclosure, the thermo-expandable microspheres may be present in the range of 0.5% to 10%, and preferably from 1% to 4%, and more preferably from 1.5 to 3% by weight of the total foam pellet (i.e., total rubber component, thermoplastic component, thermo-expandable microspheres, and any additional components or additives in the foam pellets (e.g., additive oils, fillers, and the like)), encompassing any value and subset therebetween. In some embodiments, the resultant foam pellets may have a specific gravity of 0.2 to 1.0, and preferably from 0.5 to 0.95, and more preferably from 0.7 to 0.9, where in such cases the majority of the thermo-expandable microspheres have not ruptured, encompassing any value and subset therebetween. As described above, the foam pellets according to the single-step process (and the two-step process) may advantageously be processed in a separate extruder or molder to make a foamed article. Such foam articles may have a specific gravity of 0.2 to 0.9, and preferably 0.5 to 0.8, and more preferably 0.6 to 0.7, encompassing any value and subset therebetween. Foamed articles having such specific gravities are particularly beneficial for forming low-density parts, such as the foam articles specified herein below.

### Two-Step Manufacturing of the Foam Pellets

As described in greater detail in the Examples, the foam pellets of the present disclosure may be formed in a two-step process. In some embodiments, the two-step process of the present disclosure produces a foam pellet by performing a portion of the method in a first extruder and a second portion of the method in a second extruder. It is to be noted that the particular extruder used for both portions may be the same and, moreover, that the two portions may be performed sequentially in time substantially immediately or the two portions may be separated by any period of time including days or weeks or more, without departing from the scope of the present disclosure. What distinguishes the two-step methodology is that a TPV pellet is first formed, the TPV pellet being dynamically vulcanized and cured to the extent desired, and thereafter, thermo-expandable microspheres are incorporated to form the foam pellet of the present disclosure (i.e., TPV pellets having thermo-expandable microspheres incorporated therein).

In some embodiments, the two-step method for forming the foam pellets described herein comprises introducing a rubber component to a first extruder, introducing a thermoplastic component, introducing an additive oil (e.g., as plasticizer and optionally a filler) to the first extruder, introducing a curing agent (and, optionally, an accelerator) to the first extruder. The combined components are dynamically vulcanized to at least partially vulcanize the rubber component and to form a TPV (i.e., the at least partially vulcanized rubber component and the thermoplastic component) using the first extruder. The TPV is then pelletized, such as by utilizing a pelletizing unit (e.g., a strand cut pelletizer, an underwater pelletizer, or any other pelletizing system known in the art), to form the TPV pellets, and thereafter, the TPV pellets and thermo-expandable microspheres are introduced to a second extruder, thereby blending the TPV and the thermo-expandable microspheres (as described below, the thermo-expandable microspheres may be introduced in oil slurry form in the second extruder). As defined above, it is to be understood that any of the first and second extruders may or may not perform a curing reaction (or partial reaction) therein (e.g., dynamic vulcanization), without departing from the scope of the present disclosure. For example, in some embodiments, dynamic vulcanization of the rubber and thermoplastic components is performed in the first extruder, and the thermo-expandable microspheres are introduced to the vulcanized material in the second extruder, such that no reaction (e.g., no or no substantial curing) takes place in the second extruder. Rather, the material is merely mixed and extruded from the second extruder without any reaction occurring prior to palletization. In such embodiments, the term “second extruder” encompasses any extrusion equipment or system regardless of reaction capabilities. Alternatively, the second extruder may complete dynamic vulcanization, for example, without departing from the scope of the present disclosure.

The TPV and thermo-expandable microsphere blend (which has been at least extruded from the second extruder) is then pelletized by any means known to those of skill in the art, including manual means. In some embodiments, the blend is pelletized using a pelletizing unit, such as a strand cut pelletizer or an underwater pelletizer, to form the foam pellets of the present disclosure. The first and second extruders as described above, may be the same or different, and may be, for example, a twin screw extruder or a single screw extruder. In some embodiments, the first extruder, where dynamic vulcanization may preferably take place, is preferably a twin screw extruder. The second extruder where the thermo-expandable microspheres are introduced may preferably be a single screw extruder to reduce any risk of the thermo-expandable microspheres rupturing due to relatively lower shear forces of a single screw extruder as compared to a twin screw extruder. In other embodiments, a twin screw extruder may be used as the second extruder, provided that the proper screw configuration is used to avoid significant rupture of the thermo-expandable microspheres during the extrusion process. It is to be noted, that either the first or second extruder may be either or both a single or twin screw extruder, without departing from the scope of the present disclosure.

In some embodiments, one or more additives is introduced at one or more times (or locations) during the first portion (first extruder) of the two-step process. That is, an additive may be added upstream, downstream, or simultaneously with the various components of the TPV formed in the first extruder that is pelletized to form the TPV pellets (“TPV” and “TPV pellets” do not include thermo-expandable microspheres, whereas “foam pellets” do). In some embodiments, one or more additives are added to the first extruder in the first portion of the two-step manufacturing process upstream of the curing agent (and, optionally, accelerator) and/or downstream the curing agent. For example, in some embodiments an additive of either or both of an additive oil and a particulate filler are introduced into the first extruder upstream of the curing agent (and, optionally, accelerator). In some embodiments, one or more (e.g., two) introduction of an additive oil into the first extruder occur upstream of the curing agent (and, optionally, accelerator), such as a first pill type introduction of additive oil (which may be with or without additional additives, such as a particulate filler) followed by a second pill type introduction of another (same or different) additive oil, both introductions being upstream of the curing agent (and, optionally, accelerator). The addition of the second additive oil, for example, may be more or less than the first additive oil and may be used, for instance, to further enhance the processability of the TPV.

In some embodiments, additional additive oil is introduced into the first extruder downstream of the curing agent (and, optionally, accelerator), which may be a “post-cure” additive oil when dynamic vulcanization has completed (in which case, no optional accelerator is included). This additive oil may be introduced in order to further the processability of the TPV during or after dynamic vulcanization of the rubber component, as well the processability of the TPV during fabrication part of a foam article (e.g., a weather seal).

As provided above, the TPV is pelletized and introduced with thermo-expandable microspheres into a second extruder, where the two components are blended by one or more mechanisms. As described above, the thermo-expandable microspheres may be introduced into the second extruder in their solid form, a molten form, or in a slurry dispersed in oil. In some embodiments, when included in solid, the thermo-expandable microspheres are introduced using a side crammer feeder, or alternatively by dry blending (or mixing) and feeding through a hopper to the second extruder. The terms “dry blending” or “dry mixing” refers to blending or mixing of dry components, having less than 10%, or less than 5% (including 0%) of liquid by weight of the dry components, encompassing any value and subset therebetween. In some embodiments, when the thermo-expandable microspheres are introduced to the second extruder in slurry form, they may be introduced thereto by injection.

In one or any embodiments, the two-step method described herein may utilize dense (or relatively dense) TPV pellets previously made in an extruder (e.g., a twin screw extruder) without thermo-expandable microspheres, which are used as the feedstock for thereafter forming the foam pellets of the present disclosure. For example, the TPV pellets may be thereafter compounded with thermo-expandable microspheres in a single or twin screw extruder such as by feeding them in solid form (e.g., vial dry blending (or mixing) or a side crammer feeder) for producing the foam pellets described herein having a specific gravity of 0.85 to 1.0 or 0.8 to 0.85, or preferably from 0.9 to 1.0, for example, encompassing any value and subset therebetween. That is, the resultant foam pellets may be relatively dense, included in comparison to the single-step process in some embodiments. Alternatively, using the two-step method, the TPV pellets may be compounded in a single or twin extruder with injection of the thermo-microspheres dispersed in an oil slurry for producing the foam pellets described herein having a specific gravity of 0.2 to 1.0, 0.85 to 1.0, or preferably from 0.9 to 1.0, for example. In some embodiments, unlike other foaming methods, the two-step methodologies described herein are able to produce foam pellets comprising both TPV and thermo-expandable microspheres where the thermo-expandable microspheres show minimal expansion within the foam pellet (i.e., minimal foaming takes place during the manufacturing of the foam pellet). Accordingly, in some embodiments the two-step method may be used to produce dense or relatively dense foam pellets where the majority of the expansion of the thermo-expandable microspheres (and thus foaming of the foam pellet) occurs during formation of a final foam part (e.g., a weather seal).

Any TPV system may be used in accordance with the two-step methodology, but may preferably be a polypropylene/EPDM based system, as described above. That is, the rubber component may preferably be an ethylene-propylene-diene rubber and the thermoplastic component may preferably be polyethylene, polypropylene, or a combination thereof. During the formation of the foam pellet according to the two-step method, the thermo-expandable microspheres may be introduced in a masterbatch pellet form into the second extruder by dry blending (or dry mixing, as used herein) with the TPV pellets (e.g., through a hopper), or alternatively, continuously fed in the feed throat of the second extruder using a separate feeding system (e.g., MacGuire, Conair type). Still alternatively, the thermo-expandable microspheres may be dispersed in a slurry (dust in oil) and introduced via injection at any location along the second extruder length or multiple locations to enhance and ensure homogeneous melt blending. Any combination of such introduction may be used, without departing from the scope of the present disclosure, such as if multiple types of thermo-expandable microspheres are used, or to achieve certain concentrations, to achieve certain qualities (e.g., homogeneous melt blending), and the like.

In some embodiments, and provided in greater detail above and in the Examples below, for use in the two-step method of the present disclosure, the thermo-expandable microspheres may be present in the range of 0.5% to 10%, and preferably from 1% to 4%, and more preferably from 1.5 to 3% by weight of the total foam pellet. In some embodiments, the specific gravity of the foam pellets may vary depending on the specific type of two-step method selected, which further emphasizes that a combination may be used to create results that are particularly desirable for a given application (e.g., foam article). For example, the resultant foam pellets from feeding the thermo-expandable microspheres in solid form (e.g., dry blending) into the second extruder may not be highly foamed, resulting in a specific gravity of 0.85 to 1.0, and preferably 0.88 to 0.97, and more preferably 0.9 to 0.95. As another example, the resultant foam pellets from injecting the thermo-expandable microspheres in the slurry (e.g., dispersed in oil) may have a specific gravity of 0.2 to 1.0, or more dense, such as a specific gravity of 0.85 to 1.0, and preferably 0.88 to 0.97, and more preferably 0.9 to 0.95. As described above, the foam pellets according to the two-step process (and the single-step process) may advantageously be processed in a separate extruder or molder to make a foamed article. Such foam articles may have a specific gravity of 0.2 to 0.8, and preferably 0.5 to 0.75, and more preferably 0.6 to 0.7. Foamed articles having such specific gravities are particularly beneficial for forming low-density parts, such as the foam articles specified herein below.

In some embodiments, the second extruder may have a processing temperature that is relatively low to prevent or reduce the possibility of rupture of the thermo-expandable microspheres included in the foam pellet during processing (i.e., the polymer melt comprising the thermo-expandable microspheres that correspond to the resultant foam pellet described herein). A selected low temperature may allow formation of the foam pellets without substantial expansion of the thermo-expandable microspheres prior to formation of the foam pellet or, alternatively, permit fine-tuning of the thermo-expandable microspheres to expand all or partially in the foam pellet without rupturing in the pellet or during the formation of a foam article. In some embodiments, the second extruder may have a processing temperature of less than about 185° C., or less than about 180° C., or less than about 175° C. Preferably, in some embodiments, at no point during processing the polymer melt corresponding to the resultant foam pellet in the second extruder does the temperature exceed 180° C. Preferably, in some embodiments, the second extruder will have a processing temperature higher than about 170° C.

### INDUSTRIAL APPLICABILITY

The foam pellets of the present disclosure, regardless of the methodology of their manufacture, may advantageously be formed into one or more foam articles or parts thereof. The foam pellets provide pre-included thermo-expandable microspheres, which may be already expanded, partially expanded, or un-expanded and thereafter separately process into a foam article using standard equipment. For example, the foam pellets may be extruded, injection molded, compression molded, blow molded, and/or laminated into various shaped foam articles, without the need for including any foaming agents during the formation such foam articles. The foam articles may include industrial parts such as automotive parts, electrical parts, consumer products, and the like, and any combination thereof.

The foam articles may have desirable qualities for low-density or low-specific gravity, closed cell articles. For example, the resultant foam articles from processing the foam pellets of the present disclosure may have a specific gravity in the range of 0.2 to 0.8, encompassing any value and subset therebetween, such as from a lower limit of 0.2, 0.25, 0.3, 0.35, 0.4, 0.45, and 0.5 to an upper limit of 0.8, 0.75, 0.7, 0.65, 0.6, 0.55, and 0.5, encompassing any value and subset therebetween. In some embodiments, the resultant foam articles may have a preferred specific gravity in the range of 0.4 to 0.7, encompassing any value and subset therebetween. As described above, during the formation of the foam article, the thermo-expandable microspheres in the foam pellet may be pre-expanded, partially pre-expanded, or expand during formation of the foam article, without departing from the scope of the present disclosure. Accordingly, in some embodiments, the specific gravity of the foam article may be equal to or less than the foam pellet(s) which was used to process the foam article.

In a particular embodiment, the elastomer compositions are useful in forming foam articles for use in the automotive industry. As used herein, the term “automotive,” and grammatical variants thereof, refers to any motor-driven vehicle used for motorized transportation of people, animals, and/or goods that experience vibration during use. Examples of suitable foam articles that may be formed by processing the foam pellets of the present disclosure may include, but are not limited to, a weather seal, a glass run channel, a portion of a glass run channel, a boot (e.g., an automotive boot), a bellows (e.g., an automotive bellows), a tubing, a seal, a gasket, a mechanical spline, a duct, an electronic coating, and electronic cable, a grip, a hose, and the like.

To facilitate a better understanding of the embodiments of the present disclosure, the following examples of preferred or representative embodiments are given. In no way should the following examples be read to limit, or to define, the scope of the disclosure.

### Examples

For purposes of convenience, the various specific test procedures used in the examples described herein below are identified in the Method Reference Table below. All properties were measured on extruded tapes unless otherwise indicated. As used herein, the term “tape,” and grammatical variants thereof, refers to an extruded sample, typically rectangular in shape (but not limited in shape), as dictated by a particular extruder die, used to mimic and test for characteristics which would be typical of an article formed therefrom (e.g., a foam article formed from the foam pellets of the present disclosure).

Method Reference Table

| Property | Testing Method |
|---|---|
| Specific Gravity | ASTM D-792 |
| Density | ACCUPYC ™ II 1340 Pycnometer |
| Shore A Hardness | ASTM D2250 |
| % Ultimate Elongation | ASTM D-412 (Die C) |
| Ultimate Tensile Strength | ASTM D-412 (Die C) |
| 100% Modulus | ASTM D-412 (Die C) |
| % Tension Set | ASTM D-412 (Die C) |
| % Compression Set | ASTM D-395 |

Shore A Hardness was measured on extruded tape specimens using a ZWICK automated durometer, available from Zwick USA, L.P. in Kennesaw, Ga., according to ASTM D2250 (15 second delay). Percent (%) Ultimate Elongation (UE), also referred to as % Elongation at Break; Ultimate Tensile Strength (UTS), also referred to as Tensile Strength at Break; and 100% Modulus (Modulus at 100% extension) (M100) were measured on extruded tape specimens according to ASTM D-412 (Die C) at 23° C., unless otherwise specified, at 50 mm per minute using an INSTRON® testing system, available from Instron, Norwood, Mass. Percent (%) Tension Set (TS) was measured on extruded tape specimens according to ASTM D-412 (Die C) using 100% strain at 23° C. for 10 minutes; thereafter, the specimens were permitted to relax at 23° C. for 10 minutes before measurement. Percent (%) Compression Set (CS) was measured on extruded tape specimens (stack of disks) according to ASTM D-395 using a compression strain of 25% at 70° C. for 22 hours.

Density was measured using an ACCUPYC® II 1340 Pycnometer, available from Micromeritics Instrument Corporation, Norcross, Ga., using a specimen mass of about 4-5 grams (or about 90% of the sample cup); a specimen volume of 10 cubic centimeters (cc); a purge fill pressure of 19.5 pound-force per square inch (psig) with three (3) purges; an analysis fill pressure of 19.5 psig with three (3) analyses; and an equilibrium rate of 0.020 psig per minute.

Optical microscopy images of the surface or cross-sectional areas of the foam pellets and/or foam tapes described in the Examples below were acquired using an Olympus SZX-12 stereo microscope (available from Olympus Corporation, Tokyo, Japan) equipped with a 0.055 numerical aperture Plan Fluorite 0.5× objective and a Leica DFC295 color camera (available from Leica Camera, Wetzlar, Germany). A ring light was used to provide reflected lighting. Various lighting conditions were used for the colored samples to provide adequate contrast. The foam pellet size was determined via optical microscopy using the same Olympus SZX-12 stereo microscope as previously described using IMAGE-PRO® PLUS software (e.g., version 7.0).

It is to be understood that a person of ordinary skill in the art may use various other published or well-recognized test methods to determine a particular property of the foam compositions described herein, without departing from the scope of the present disclosure, although the specifically identified procedures are preferred. Each claim should be construed to cover the results of any of such procedures, even to the extent different procedures may yield different results or measurement values.

### Example 1—Single-Step Method

Foam Pellets of Example 1: A co-rotating, fully intermeshing type twin screw ZSK 53 mm extruder (available from Coperion Corporation, Ramsey, N.J.) was used following a method similar to that described in U.S. Pat. No. 4,594,391 and U.S. Patent Pub. No. 2011/0028637, the entireties of which are herein incorporated by reference. VISTALON™ V3666 rubber component (an EPDM rubber available from ExxonMobil Chemical Company, Houston, Tex.) was fed into the feed throat of the ZSK 53 extruder of L/D (length of extruder over its diameter) of about 46.7. Polypropylene PP5341 thermoplastic component (a homopolymer polypropylene resin available from ExxonMobil Chemical Company, Houston, Tex.) was also fed into the feed throat, along with other reaction rate control agents, such as zinc oxide curing agent (e.g., ZOCO™ 102C, available from Zochem Inc., Ontario. Canada), phenolic resin curing agent (e.g., SMD 31215S resin (30%)-in-oil (70%), available from SI Group, Inc., Schenectady, N.Y.), and stannous chloride accelerator. Particulate fillers, such as clay (e.g., ICECAP-K™, available from Burgess Pigment Company, Sandersville, Ga.) and carbon black MB (e.g., AMPACET™ 49974, available from Ampacet Corporation. Tarrytown, N.Y.), were also added into the extruder feed throat. Additive oil (e.g., paraffinic oil for processing, such as SUNPAR™ 150M, available from HollyFrontier Refining & Marketing LLC, Plymouth Meeting, Pa.) was injected into the extruder at two different locations along the extruder. The curing agent was injected into the extruder after all of the rubber component, the thermoplastic component, the accelerator, acid scavenger, and particulate fillers were fed into the extruder hopper, at about an L/D of 25.5, and after the introduction of first processing oil (pre-cure oil), which was introduced at about an L/D of 4.5. A second additive (e.g., processing) oil (post-cure oil) was injected into the extruder after the curing agent injection at about an L/D of 34.5. Dynamic vulcanization of the rubber component (e.g., crosslinking reactions) were initiated and controlled by balancing a combination of viscous heat generation due to application of shear, barrel temperature set point, use of catalysts, and residence time. A slurry of EXPANCEL™ 980DU120 expandable microspheres (available from AkzoNobel, Amsterdam, Netherlands) in SUNPAR™ 150M paraffinic oil (available from Sunoco, Dallas, Tex.) (10% wt. EXPANCEL™ 980DU120/90)% wt. SUNPAR™ 150M oil) was injected at location of about L/D=40.

The total mass throughput (abbreviated as “thru-put” in the below Tables), including the thermo-expandable microsphere slurry, was 75 kilograms per hour (kg/hr) and the extruder screw rotation speed was 270 revolutions per minute (RPM) or 320 RPM, as shown in Table 2. A barrel metal temperature profile in ° C., starting from barrel section 2 down towards the die to barrel section 12 of 130/140/150/160/170/170/180/190/200/200/170/160/160/160/200° C. (wherein the last value is for the die) was used for the runs of the present Example, where the thermo-expandable microspheres were introduced to form foam pellets according to one or more embodiments described herein.

Comparative examples were also evaluated using dense TPV pellets, either commercially available or prepared as described. As used herein, the terms “dense TPV pellet(s)” or simply “TPV pellet(s),” and grammatical variants thereof, refers to a TPV pellet containing no (the absence) of thermo-expandable microspheres. These TPV pellets are accordingly distinguished from the foam pellets of the present disclosure, which have incorporated therein a homogeneous (or near homogeneous) distribution of thermo-expandable microspheres, which can thereafter beneficially be formed into a foam article. In the case of dense TPV pellets, such as comparative example C6, the extruder temperature profile was 130/140/150/160/170/170/180/190/200/200/180/180/160/170/200° C. Generally, the temperature profile ranges may be selected based on standard TPV profiles (e.g., higher barrel temperatures at later stages). In some instances of the present disclosure for forming the foam pellets having thermo-expandable microspheres incorporated therein, it may be desirable to reduce the temperature to reduce expansion and/or potential rupture of the thermo-expandable microspheres. Low molecular weight contaminants, reaction by-products, residual moisture, and the like were removed by venting through one or more vent ports, typically under vacuum, as needed.

The final product was filtered using a melt gear pump and a filter screen of desired mesh size 20/100/20. It is noted, however, that preferably, exclusion of the use of melt gear pump and/or filter screen may reduce or prevent rupture of the thermo-expandable microspheres during formation of the foam pellet. A screw design with several mixing sections, including a combination of forward convey, neutral, left-handed kneading blocks, and left-handed convey elements were used to mix the additive oil, cure agents, and other additives and to provide sufficient residence time and shear for completing the cure reaction of the single-step method, without slipping or surging in the extruder. A Gala underwater pelletizer connected to the 53 mm twin screw extruder was used to make foam pellets according to Example 1 (E1-1, E1-2, and E2) and comparative examples (C1, C2, C3, C4, and C6).

Foam Tapes of Example 1: The foam pellets and comparative examples prepared in accordance with Example 1 were further used to make extruded samples mimicking a portion of a foam article-tapes-using a slit die on a 1-inch Killion Model EX4966 single screw extruder (originally supplied by Killion Extruders, Inc., Cedar Grove, N.J.). The Killion extruder L/D was about 25 and the die dimensions were about 1 inch (width)×about 0.01 inch (thickness). The extruder included 3 heating zones. The extruder temperature profile from Zone 1 to the die is 356/374/392/400° F. (180/190/200/204.4° C.) and the screw speed is 86 RPM. No screen pack was used in any of the experiments.

Additionally, the foam pellets and comparative samples of the present disclosure prepared in accordance with Example 1 were used to make tapes using a different extruder (e.g., which can be compared to the tapes formed using the Killion extruder described above). The tapes were prepared using a slit die on a 1.5-inch (screw diameter) Davis-Standard (D-S) single screw extruder (supplied by Davis-Standard, Pawcatuck, Conn.). The extruder L/D was 24 and the slit die dimensions were about 1 inch (width)×about 0.08 inch (thickness) (i.e., thicker tape geometry than the tape geometry formed on the Killion Model above). From the foam pellet examples (experimental), sample E1-2 was used from Table 1 to form the tapes on the Davis-Standard extruder; and from the comparative examples, sample C6 was used from Table 1. The extruder had 4 heating zones.

No screen pack was used in any of the experiments for forming the tapes for both the Killion and 1.5-inch Davis-Standard single screw extruders. In the case of the Davis-Standard single screw extruder, the tapes exiting the die were deposited on a conveying belt and allowed to cool and crystallize at ambient temperature. For each extrusion condition, the throughput was measured by collecting and weighing tape extrudate exiting the die for a period of 1 minute (min). For each run condition, a transition period of 10 min was let to lapse to achieve steady state conditions before samples were collected. After the 10 min transition period, the duration of each run was 25 min total. Tapes were collected every 5 min (5 tapes over the running period of 25 min). The specific gravity (SG) of the 5 tapes was measured for each testing condition and the average is reported below. The SG of the tapes was measured according to ASTM D-792. The standard deviation of the SG measurements for tapes of same run over the period of 25 min was in the range of 0.001-0.004 for the foam pellets (e.g., E1-2 and E2 from Table 1).

Comparative extruder runs were also executed, using sample C6 from Table 1 (i.e., TPV pellets having no thermo-expandable microspheres) as the feedstock to make tapes. The C6 samples were dry blended with 1% by weight of EXPANCEL™ 980MB120 thermo-expandable microspheres in pellet form, from a masterbatch containing 65% by weight of the thermo-expandable microspheres in ethylene-vinyl-acetate (EVA) carrier polymer (available from Akzo-Nobel, Amsterdam, Netherlands). The dry blend of the C6 TPV pellets with the thermo-expandable microspheres were fed into the extruder hopper and processed as described above to produce tapes. The standard deviation of the SG measurements for tapes made out of the dry blend of C6 TPV pellets with the thermo-expandable microspheres over a period of 25 min was in the range of 0.01-0.02, which is an order of magnitude higher than that of tapes made from the foam pellets of the instant disclosure (i.e., having built-in thermo-expandable microspheres, which was 0.001-0.004). Accordingly, the foam pellets of the present disclosure produced according to the single-step method described herein advantageously resulted in tapes (and, thus, foam articles) with more consistent specific gravity compared to TPV pellets mixed with thermo-expandable microspheres during the formation of a foamed article (as is traditional).

Tables 1, 2, and 3 provide the various details of Example 1, as described below.

Table 1: Formulations for single-step foam pellets according to the present disclosure are provided. Comparative (C) (i.e., TPV pellets without any thermo-expandable microspheres (and further that do not include the processing elements, components, amounts, and/or combinations characteristic of the defined foam pellets herein and/or are not made according to the methods described herein) and Experimental (E) samples prepared according to the embodiments described herein are provided. The formulations are expressed in phr, as defined herein. Notably, E1-2 includes VISTAMAXX™ VM3020, whereas E2 does not, demonstrating that a thermoplastic modifier need not be included; further, the specific gravity of E2 (absent the thermoplastic modifier) of both the foam pellet and the tape are considerably less as compared to E1-2, as shown in Table 2.

TABLE 1

| Ingredient | C1 | C2 | C3 | C1-1 | C5 | E1-2 | E2 | C6 |
|---|---|---|---|---|---|---|---|---|
| Vistalon ™ V3666 EPDM | 175 | 175 | 175 | 175 | 175 | 175 | 175 | 175 |
| (100 phr in 75 phr Sunpar ™ 150M oil) | | | | | | | | |
| ExxonMobil PP5341 Polypropylene | 87 | 87 | 87 | 87 | 87 | 87 | 87 | 87 |
| VISTAMAXX ™ VM3020 | 42.25 | 42.25 | 42.25 | 42.25 | 0 | 42.25 | 0 | 42.25 |
| Icecap-K ™ Clay | 42 | 42 | 42 | 42 | 42 | 42 | 42 | 42 |
| Zoco ™ 102 Zinc Oxide | 1.5 | 1.5 | 1.5 | 1.5 | 1.5 | 1.5 | 1.5 | 1.5 |
| SnCl2 MB | 1.67 | 1.67 | 1.67 | 1.67 | 1.67 | 1.67 | 1.67 | 1.67 |
| Ampacet 49974 Carbon Black MB | 11 | 11 | 11 | 11 | 11 | 11 | 11 | 11 |
| Pre-Cure Oil Sunpar ™ 150M | 7.8 | 7.8 | 7.8 | 7.8 | 7.8 | 7.8 | 7.8 | 7.8 |
| Resin in Oil (SMD 31215S) | 12.80 | 12.80 | 12.80 | 12.80 | 12.80 | 12.80 | 12.80 | 12.80 |
| Post-Cure Oil Sunpar ™ 150M | 16.53 | 16.53 | 22.75 | 16.53 | 16.53 | 4.09 | 4.09 | 41.40 |
| EXPANCEL ™ 980DU120 Slurry | 27.63 | 27.63 | 20.72 | 27.63 | 27.63 | 41.46 | 41.46 | 0.00 |
| (10% EXPANCEL 980DU120/90% | | | | | | | | |
| Sunpar ™ 150M) | | | | | | | | |

Table 2: Shown are the 53 mm twin screw extruder process conditions for single-step foam pellets (E1-2 and E2) and comparative examples according to Example 1, and corresponding pellet density and specific gravity (SG) of tapes made therefrom on two different extruders. The formulations correspond to those of Table 1. The tapes were made with the 1-inch Killion single screw extruder or the 1.5-inch Davis-Standard single screw extruder, as described hereinabove, and at the temperatures provided herein (see Table 3 and description hereinabove). The lowest achievable density and specific gravity are reported in Table 2.

TABLE 2

| | | | | Use of | | | 1.5-inch |
|---|---|---|---|---|---|---|---|
| | | | | Screen | | | Davis- |
| | | | % wt | Pack to | | 1-inch | Standard |
| | Screw | Through | EXPANCEL ™ | Form | Pellet | Killion | Lowest |
| | Speed | put | 980DU120 | Foam | Density | Tape | Achievable |
| Ex. | (rpm) | (kg/hr) | (solid) | Pellet | (g/cm³) | SG | Tape SG |
| C1 | 270 | 75 | 0.65 | 20/100/20 | 0.858 | 0.882 | 0.932 |
| C2 | 320 | 90 | 0.65 | 20/100/20 | 0.886 | 0.846 | 0.931 |
| C3 | 2.70 | 75 | 0.49 | 20/100/20 | 0.905 | 0.880 | N/A |
| C1-1 | 270 | 75 | 0.65 | 20/100/20 | 0.907 | 0.832 | N/A |
| C5 | 320 | 90 | 0.72 | 20/100/20 | 0.877 | 0.832 | 0.913 |
| E1-2 | 2.70 | 75 | 0.97 | 20/100/20 | 0.842 | 0.883 | 0.820 |
| E2 | 270 | 75 | 1.08 | 20/100/20 | 0.745 | 0.762 | 0.688 |
| C6 | 320 | 90 | 0.00 | 20/100/20 | 0.949 | N/A | 0.682 |

Table 3: 1.5-inch Davis-Standard single screw tape extrusion conditions and corresponding tape specific gravity is shown for comparative (S-C) and experimental example (S-E) tapes of the single-step method of Example 1. S1-C1, S2-C1, and S3-C1 are comparative example tapes each made from comparative pellets C1 (shown in Tables 1 and 2). S1-C2, S2-C2, and S3-C2 are comparative example tapes each made from comparative pellets C2 (shown in Tables 1 and 2). S1-C5, S2-C5, and S3-C5 are comparative example tapes each made out of comparative pellets C5 (shown in Tables 1 and 2). S1-E1-2, S2-E1-2, S3-E1-2 are experimental example tapes each made from experimental pellets E1-2 (shown in Tables 1 and 2). S1-E2, S2-E2, and S3-E2 are experimental example tapes each made from experimental pellets E2 (shown in Tables 1 and 2). Each of the comparative and experimental example tapes were produced with the Davis-Standard single screw extruder conditions depicted in Table 3. Extruder process conditions, SG and mechanical properties of tapes made on 1.5-inch Davis-Standard single screw extruder for comparative sample C6 (S1-C6 and S2-C6) are depicted in Table 6.

Where tested, the mechanical properties of each sample are provided in Table 3. The symbol “-” indicates that the particular mechanical property was not tested.

TABLE 3

| Extruder | | | | | | | S1- | S2- |
|---|---|---|---|---|---|---|---|---|
| Condition | S1-C1 | S2-C1 | S3-C1 | S1-C2 | S2-C2 | S3-C2 | E1-2 | E1-2 |
| Zone 1 Temp (° F.) | 323 | 342 | 362 | 319 | 340 | 362 | 318 | 337 |
| Zone 2 Temp (° F.) | 351 | 371 | 392 | 349 | 368 | 389 | 350 | 372 |
| Zone 3 Temp (° F.) | 370 | 391 | 411 | 370 | 390 | 411 | 370 | 390 |
| Zone 4 Temp (° F.) | 381 | 400 | 417 | 379 | 401 | 419 | 379 | 400 |
| Die Temp (° F.) | 400 | 420 | 440 | 400 | 420 | 440 | 400 | 420 |
| Motor Current (Amps) | 4.1 | 3.8 | 3.2 | 4.4 | 3.7 | 3.3 | 4.2 | 3.7 |
| Screw Speed (rpm) | 45 | 45 | 45 | 45 | 45 | 45 | 45 | 45 |
| Through-put (lbs/hr) | 16.8 | 16.8 | 16.8 | 16.8 | 16.8 | 16.8 | 16.8 | 16.8 |
| Melt Temp (° F.) | 357 | 370 | 384 | 355 | 364 | 386 | 347 | 365 |
| Tape SG | 0.941 | 0.940 | 0.939 | 0.936 | 0.935 | 0.932 | 0.820 | 0.880 |
| Corresponding Pellet Density | 0.858 | 0.858 | 0.858 | 0.886 | 0.886 | 0.886 | 0.842 | 0.842 |
| From Table 2 (g/cm³) | | | | | | | | |
| Shore A Hardness | — | 86.4 | — | — | — | — | 76.4 | — |
| 100% Modulus (MPa) | — | 5.5 | — | — | — | — | 4.4 | — |
| Ultimate Tensile Strength (MPa) | — | 10.5 | — | — | — | — | 5.8 | — |
| % Ultimate Elongation (%) | — | 448 | — | — | — | — | 239 | — |
| % Tension Set (%) | — | 16 | — | — | — | — | 18 | — |

| Extruder | S3- | | | | | | |
|---|---|---|---|---|---|---|---|
| Condition | E1-2 | S1-C5 | S2-C5 | S3-C5 | S1-E2 | S3-E2 | S3-E2 |
| Zone 1 Temp (° F.) | 364 | 318 | 339 | 359 | 322 | 340 | 357 |
| Zone 2 Temp (° F.) | 385 | 348 | 370 | 391 | 351 | 371 | 393 |
| Zone 3 Temp (° F.) | 410 | 370 | 389 | 410 | 370 | 390 | 410 |
| Zone 4 Temp (° F.) | 419 | 380 | 400 | 420 | 380 | 404 | 419 |
| Die Temp (° F.) | 440 | 399 | 419 | 435 | 400 | 415 | 440 |
| Motor Current (Amps) | 3.3 | 4.2 | 3.5 | 3.0 | 4 | 3.2 | 3 |
| Screw Rotation Speed (rpm) | 45 | 45 | 45 | 45 | 45 | 45 | 45 |
| Throughput (lbs/hr) | 16.8 | 15.6 | 16.2 | 16.2 | 16.4 | 15.4 | 16.1 |
| Melt Temp (° F.) | 381 | 354 | 363 | 374 | 352 | 357 | 366 |
| Tape SG | 0.877 | 0.928 | 0.926 | 0.913 | 0.688 | 0.690 | 0.691 |
| Corresponding Pellet Density | 0.842 | 0.877 | 0.877 | 0.877 | 0.745 | 0.745 | 0.745 |
| (g/cm³) From Table 2 | | | | | | | |
| Shore A Hardness | — | — | — | — | 69.7 | 70.1 | 69.8 |
| 100% Modulus (MPa) | — | — | — | — | 3.5 | 3.5 | 3.5 |
| Ultimate Tensile Strength (MPa) | — | — | — | — | 4.5 | 4.6 | 4.3 |
| % Ultimate Elongation (%) | — | — | — | | 221 | 223 | 204 |
| % Tension Set (%) | — | — | — | — | 16 | 19 | 18 |

As shown in Example 1, and in some embodiments of the present disclosure, experimental foam pellets E1-2 and E2 prepared according to the single-step method described herein comprise 0.97% and 1.08% by weight solid thermo-expandable microspheres, respectively, based on the weight of the total foam pellet. The foam pellets of experimental examples E1-2 and E2 exhibit a density of 0.842 g/cm³ and 0.745 g/cm³ prior to any formation into a foam article (e.g., the tapes of the instant Example). After forming the foam article (tapes), the experimental foam pellets E1-2 and E2 exhibit a lowest specific gravity of 0.820 (S1-E1-2) and 0.688 (S1-E2), demonstrating that the thermo-expandable microspheres further expanded during formation of the foam article. Notably, foam pellet E2 may surprisingly have a lower density (specific gravity) in foam pellet form and corresponding article form (tape) compared to E1-2, which has the same formulation except for the addition of a thermoplastic modifier (VISTAMAXX™ 3020). Without being bound by theory, it is believed that the absence or a reduced amount of the thermoplastic modifier may allow the thermo-expandable microspheres to expand greater during the single-step process.

### Example 2—Two-Step Method

Comparative TPV dense pellets (i.e., not containing thermo-expandable microspheres) along with other additives in pellet form described in Table 4 were fed into the feed throat of the ZSK 53 twin screw extruder of L/D (length of extruder over its diameter) of about 46.7 described previously. The TPV pellets were either commercially available SATOPRENE™ 101-80 (available from ExxonMobil Chemical Company, Houston, Tex.) or they were made on the 53 mm twin screw extruder described in Example 1 above for forming the C6 pellet sample per Table 1 (i.e., absent any thermo-expandable microspheres). A slurry of 10 wt. % or 20% wt. % EXPANCEL™ 980DU120 thermo-expandable microspheres in 90 wt. % or 80 wt. % PARAMOUNT™ 6001R paraffinic oil (available from ChevronTexaco, San Ramon, Calif.), respectively, was injected at a certain location along a second extruder as provided in Table 5. That is, a TPV pellet was prepared in one extruder and the thermo-expandable microspheres were added in a different extruder (or during a different extrusion process, regardless of the exact extruder).

The dense TPV pellets and the thermo-expandable microspheres, where applicable, (and any other additives) were fed into the extruder at a throughput rate of 75 kg/hr or 110 kg/hr and an extruder screw speed of 300 revolutions per minute (RPM) as shown in Table 5. A barrel metal temperature profile in ° C. starting from barrel section 2 down towards the die to barrel section 12 of 80/140/150/160/170/170/150/130/120/120/110/110/110/110/T_{die} ° C. (wherein the last value is for the die) was used for the runs where thermo-expandable microspheres were introduced to the TPV pellets. The die temperature T_{die} is shown for each run in Table 6. Low molecular weight contaminants, reaction by-products, residual moisture and the like were removed by venting through one or more vent ports, typically under vacuum, as needed. No melt gear pump was used. A filter screen of desired mesh size (20/100/20) was used in selected runs (labeled “Y” in Table 5). A Gala underwater pelletizer connected to the 53 mm twin screw extruder was used to make TPV pellets including the thermo-expandable microspheres (i.e., foam pellets). Tapes for one or more examples were prepared using the foam pellets (described in Tables 1 and 2) with the Killion and Davis-Standard extruders, respectively, according to the methods described in Example 1 above, and as shown in Tables 5 and 6 below.

Table 4: Formulations for Comparative (C) (i.e., TPV pellets without thermo-expandable microspheres included of SANTOPRENE™ 101-80 TPV, SANTOPRENE™ TPV is available from ExxonMobil Chemical Company. Houston. Tex.) and Experimental (E) foam pellet samples prepared according to the two-step methods described herein are provided. The symbol “-” indicates that the particular component was not included. The C7 comparative pellet was produced by passing (re-extruding) comparative pellet C6 (Table 1) through the 53 mm twin screw extruder without addition of any thermo-expandable microspheres.

TABLE 4

| Ingredient | E3 | E4 | E5 | E6 | E7 | E8 | E9 |
|---|---|---|---|---|---|---|---|
| SANTOPRENE ™ 101-80 Pellets | 93.85 | 93.85 | 93.85 | 93.85 | 96.84 | 87.15 | — |
| C6 TPV Pellets (Tables 1 & 2) | — | — | — | — | — | — | 96.84 |
| VISTAMAXX ™ VM3020 Pellets | — | — | — | — | — | 9.69 | — |
| EXPANCEL ™ 980DU120 Slurry | 6.15 | 6.15 | 6.15 | 6.15 | — | — | — |
| (10% EXPANCEL ™ 980DU120/ | | | | | | | |
| 90% Paramount ™ 6001R) | | | | | | | |
| EXPANCEL ™ 980DU120 Slurry | — | — | — | — | 3.16 | 3.16 | 3.16 |
| (20% EXPANCEL ™ 980DU120/ | | | | | | | |
| 80% Paramount ™ 6001R) | | | | | | | |
| Ingredient | E10 | E11 | E12 | E13 | E14 | E15 | C7 |
| SANTOPRENE ™ 101-80 Pellets | — | — | — | — | — | — | — |
| C6 TPV Pellets (Table 1 & 2) | 96.84 | 96.84 | 96.84 | 96.84 | 96.84 | 96.84 | 100 |
| VISTAMAXX ™ VM3020 Pellets | — | — | — | — | — | — | — |
| EXPANCEL ™ 980DU120 Slurry | — | — | — | — | — | — | — |
| (10% EXPANCEL ™ 980DU120/ | | | | | | | |
| 90% Paramount ™ 6001R) | | | | | | | |
| EXPANCEL ™ 980DU120 Slurry | 3.16 | 3.16 | 3.16 | 3.16 | 3.16 | 3.16 | — |
| (20% EXPANCEL ™ 980DU120/ | | | | | | | |
| 80% Paramount ™ 6001R) | | | | | | | |

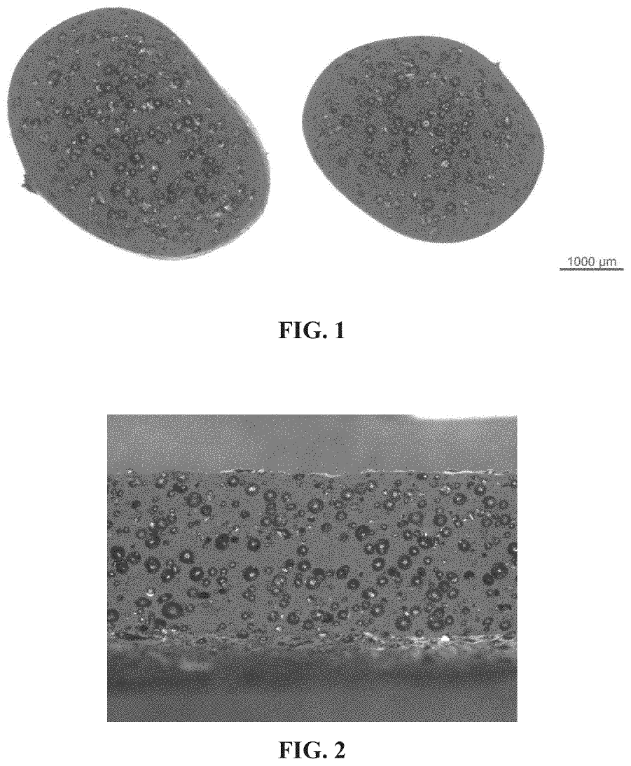

Table 5: Shown are the 53 mm twin screw extruder process conditions for two-step foam pellets (“E” examples) and comparative pellets (“C” examples) according to Example 2. The 53 mm twin screw conditions are based on the second step in the two-step process (the TPV can be formed without the thermo-expandable microspheres in accordance with Example 1; see C6), and corresponding pellet density and specific gravity of corresponding tapes made using the 1-inch Killion extruder (as described in Example 1) are listed. FIG. 1 depicts an optical microscopy image of a cross-sectional area of the foam pellet E12, showing expanded thermo-expandable microspheres therein (see the foam pellet density shown in Table 5).

TABLE 5

| | | | | Screw | Use of | | | |
|---|---|---|---|---|---|---|---|---|
| | | | % wt. | Location | Screen | Die | TPV | 1-inch |
| | Screw | | EXPANCEL ™ | (L/D) of | Pack on | Temp | Pellet | Killion |
| | Speed | Thru-put | 980DU120 | Slurry | 2^{nd} Step | T_{die} | Density | Tape |
| Ex. | (rpm) | (kg/hr) | (solid) | Injection | Extrusion | (° C.) | (g/cm³) | SG |
| E3 | 300 | 75 | 0.614 | 40 | — | 190 | 0.705 | 0.686 |
| E4 | 300 | 110 | 0.614 | 40 | — | 210 | 0.779 | 0.762 |
| E5 | 300 | 110 | 0.614 | 40 | Y | 210 | 0.685 | 0.719 |
| E6 | 300 | 110 | 0.614 | 40 | Y | 210 | N/A | 0.675 |
| E7 | 300 | 110 | 0.634 | 39 | Y | 210 | 0.674 | 0.714 |
| E8 | 300 | 110 | 0.634 | 39 | Y | 210 | 0.667 | 0.709 |
| E9 | 300 | 110 | 0.634 | 39 | Y | 210 | 0.700 | 0.761 |
| E10 | 300 | 75 | 0.634 | 39 | Y | 210 | 0.715 | 0.703 |
| E11 | 300 | 110 | 0.634 | 42 | Y | 210 | 0.710 | 0.811 |
| E12 | 300 | 110 | 0.634 | 42 | Y | 210 | 0.722 | 0.692 |
| E13 | 300 | 75 | 0.634 | 42 | Y | 190 | 0.700 | 0.758 |
| E14 | 300 | 75 | 0.634 | 22 | Y | 210 | 0.728 | 0.726 |
| E15 | 300 | 75 | 0.634 | 22 | Y | 210 | 0.853 | 0.878 |
| C7 | 300 | 75 | 0 | — | Y | 210 | 0.904 | 0.940 |

Table 6: 1.5-inch Davis-Standard single screw tape extrusion conditions and corresponding tape SG for comparative example (S-C) and experimental example (S-E) tapes of the two-step method of Example 2 are provided. S1-E12 and S2-E12 are experimental example tapes each made from experimental example foam pellets E12 (shown in Tables 4 and 5). S1-C6 and S2-C6 are each made from comparative pellet C6 (shown in Tables 1 and 2). Each of experimental and comparative examples were produced with the 1.5-inch Davis-Standard single screw extruder conditions depicted in Table 6.

TABLE 6

| Extruder Condition | S1-E12 | S2-E12 | S1-C6 | S2-C6 |
|---|---|---|---|---|
| Zone 1 Temp (° F.) | 318 | 337 | 320 | 344 |
| Zone 2 Temp (° F.) | 348 | 374 | 350 | 368 |
| Zone 3 Temp (° F.) | 370 | 390 | 370 | 390 |
| Zone 4 Temp (° F.) | 380 | 400 | 381 | 400 |
| Die Temp (° F.) | 400 | 417 | 400 | 420 |
| Motor Current (Amps) | 3.8 | 3.1 | 4 | 3.8 |
| Screw Speed (rpm) | 45 | 45 | 45 | 45 |
| Throughput (lbs/hr) | 17.4 | 16.8 | 17.9 | 16.2 |
| Melt Temp (° F.) | 356 | 364 | 359 | 369 |
| Tape SG | 0.671 | 0.740 | 0.693 | 0.710 |
| Corresponding Pellet Density | 0.722 | 0.722 | 0.949 | 0.949 |
| (g/cm³) From Tables 2 and 5 | | | | |
| Shore A Hardness | 67.4 | 72.0 | 67.8 | 70.8 |
| 100% Modulus (MPa) | 3.4 | 3.6 | 3.6 | 3.7 |
| Ultimate Tensile Strength (MPa) | 4.8 | 5.2 | 4.5 | 4.9 |
| % Ultimate Elongation (%) | 293 | 296 | 247 | 270 |
| % Tension Set (%) | 20 | 22 | 20 | 22 |

Table 6 depicts that the SG and mechanical properties of experimental tapes S1-E12 and S2-E12 made from the experimental foam pellets E12 have overall similar SG and mechanical properties, with advantageously higher % Ultimate Elongation compared to those of comparative tapes S1-C6 and S2-C6, respectively, each made from dense TPV pellets (C6) with the thermo-expandable microcapsules being dry blended in the 1.5-inch Davis Standard tape extruder. The mechanical properties of the experimental examples S1-E12 and S2-E12 are surprisingly on par and/or advantageous over those of the comparative examples S1-C6 and S2-C6, despite the fact that the thermo-expandable microcapsules in the foam pellets of E12 are already expanded to a great extent (E12 foam pellet density of 0.722) without being ruptured during extrusion on the 1.5-inch Davis-Standard tape extruder. Accordingly, foam articles (e.g., as represented by the tapes herein) can advantageously be produced by directly using the inventive foam pellets described in the present disclosure, without the complexity of adding any thermo-expandable microcapsules during extrusion of the foam article, while maintaining desired foam mechanical properties. FIG. 2 depicts an optical microscopy image of a cross-sectional area of the foam tape S1-E12, showing the thermo-expandable microspheres therein, which are further expanded (e.g., decreased density) as compared to the E12 foam pellet (FIG. 1).

### Example 3—Two-Step Manufacturing Using HAAKE™ Single Screw Extruder

A HAAKE™ 252 single screw extruder (available from Thermo Fisher Scientific, Waltham, Mass.) was used to perform a two-step method of the present disclosure for producing the foam pellets described herein. In this example, the Haake single screw extruder was used because it is believed, without being bound by theory, that its size and configuration permit good temperature control, and thus good control of the expansion of the thermo-expandable microspheres (e.g., to prevent or reduce rupturing) to further evaluate the embodiments described herein. The extruder screw diameter was ¾ inch, the ratio of length over screw diameter (LID) was 25:1, and the compression ratio was 3:1. Dense TPV pellets of SANTOPRENE™ 161-80F260 (available from ExxonMobil, Houston, Tex.) (i.e., pellets not containing any thermo-expandable microspheres) were dry blended with thermo-expandable microspheres EXPANCEL® 980MB120 (available from Akzo-Nobel, Amsterdam, Netherlands) in pellet form. EXPANCEL™ 980MB120 is in the form of a masterbatch containing 65 wt. % thermo-expandable microspheres in ethylene-vinyl-acetate (EVA) carrier polymer (available from Akzo-Nobel, Amsterdam, Netherlands). Experimental sample E16 and Comparative sample C8 were used in this Example 3, and their compositions are provided in Table 7 below. E16 foam pellets were prepared by dry blending the dense TPV pellets with the thermo-expandable microspheres, followed by feeding the blend into the extruder hopper. E16 tapes were processed as described in the preceding Examples. A rod die was used with a diameter of 3 mm, and the cylindrical strand was passed through a water bath and then entered into a strand-cut pelletizer (Berlyn model # PEL-2, 20 volt/2.5 amps, available from Berlyn EMC, Inc., Worcester, Mass.) to produce the pellets. No screen pack was used in the extruder. The mass throughput was determined in pounds per hour (lbs/hr) by collecting and weighing pellets exiting the pelletizer over a period of time, typically 2 minutes. The specific energy input (SEI) was estimated using the following equation, Equation B.

$$SEI = \frac{1}{4 \text{,} 331.488} * \frac{T * n}{W} , \qquad Equation B$$

where SEI is the specific energy input in kilowatt hour per kilogram (kw-hr/kg), T is the torque in newton meters (N m), n is the screw rotation speed in revolutions per minute (rpm)(rev/min), W is the mass throughput in pounds per hour (lbs/hr), and 4,331.488 is a unit conversion factor. Extruder conditions and the density of the two-step method for forming the foam pellets and comparative examples are summarized in Table 8. Melt temperature, as shown in Table 8, was measured in the bulk of the melt with an infrared sensor at a location between the end of the screw and the die.

Table 7: Formulation of the two-step method experimental example foam pellets (E) and comparative example pellets (C) are provided in Table 7, where the second step is made with a Haake single extruder. The compositions are expressed in wt. %. EXPANCEL™ 980MB120 is a master batch containing 65% by weight of the thermo-expandable microspheres 980DU120 in ethylene-vinyl-acetate (EVA) carrier polymer (available from Akzo-Nobel, Amsterdam. Netherlands). Accordingly, the estimated amount of pure thermo-expandable microspheres in the foam pellet E16 below is 0.975 wt. % of the total formulation composition.

TABLE 7

| Ingredient | E16 | C8 |
|---|---|---|
| SANTOPRENE ™ 161-80F260 Pellets (wt. %) | 98.5 | 100 |
| EXPANCEL ™ 980MB120 Pellets (wt. %) | 1.5 | 0 |

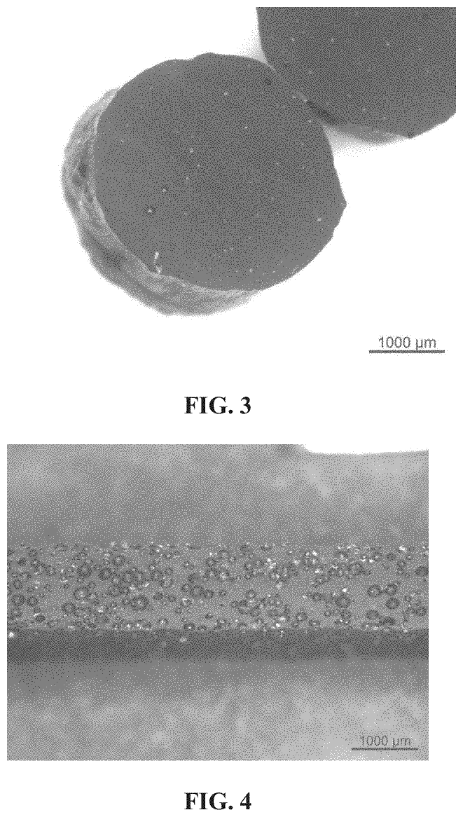

Table 8: Haake screw extruder process conditions for the two-step method for forming foam pellets of the present disclosure and comparative pellets, and corresponding pellet density for the comparative (C) and experimental (E) examples, are provided in Table 8. The formulations correspond to those depicted in Table 7. FIG. 3 depicts an optical microscopy image of a cross-sectional area of the foam pellet E16-3, which exhibits are rather high density and shows rather minimal expanded thermo-expandable microspheres therein (e.g., as compared to FIG. 1).

TABLE 8

| Extruder Condition | E16-1 | E16-2 | E16-3 | C8-RE* |
|---|---|---|---|---|
| Barrel Zone 1 Temperature | 159 | 150 | 141 | 139 |
| (° C.) | | | | |
| Barrel Zone 2 Temperature | 179 | 171 | 159 | 159 |
| (° C.) | | | | |
| Barrel Zone 3 Temperature | 190 | 182 | 171 | 171 |
| (° C.) | | | | |
| Die Zone Temperature | 190 | 179 | 171 | 168 |
| (° C.) | | | | |
| Melt Temperature (° C.) | 163 | 159 | 150 | 150 |
| Screw Torque (N-m) | 17.1 | 18.3 | 25.1 | 39.2 |
| Screw Rotation Speed (rpm) | 49.9 | 49.9 | 49.9 | 49.9 |
| Head Pressure (psi) | 484 | 635 | 1218 | 1219 |
| Throughput (kg/hr) | 1.56 | 1.26 | 1.36 | 1.76 |
| Specific Energy Input | 0.057 | 0.076 | 0.097 | 0.116 |
| (SEI) (Kw − hr/kg) | | | | |
| Foam Pellet Density (g/cm³) | 0.773 | 0.900 | 0.942 | 0.950 |

*C8-RE refers to re-extruded C8 pellets (composition shown in Table 7) on the HAAKE ™ single screw extruder (no expandable microcapsules included).

As shown, E16-1 has a relatively low density compared to E16-2 and E16-3, which is believed to be due to the elevated processing temperature (i.e., greater than 190° C.) which is thought to have caused the thermo-expandable microspheres to expand, thus resulting in a lower density. Alternatively, and in some embodiments preferably, a lower processing temperature (i.e., less than 185° C.) is desired to prevent expansion of the thermo-expandable microspheres, such that expansion occurs during processing of the foam pellet into a foam article.

The two-step method experimental foam pellets (E16-1, -2, -3) described in Tables 7 and 8 and the comparative example (C8) were used to make tapes using a flat (rectangular) die on the Haake 252 single screw extruder described above. The flat die dimensions were used to make tapes having approximate dimensions of 50 mm (width)×1 mm (thickness). No screen pack was used in any of the experiments. The tapes exiting the die were deposited on a conveying belt and allowed to cool and crystallize at ambient temperature conditions. For each extrusion condition, the throughput was measured by collecting and weighing tape extrudate exiting the die for a period of 2 min. For each run condition, a transition period of about 5 min was let to lapse to achieve steady state conditions before samples were collected. After the 5 min transition period, the duration of each run was 15 min. Tapes were collected throughout the 15 min run period. The specific gravity (SG) of 5 tape samples was measured for each condition and the average was reported. The standard deviation of the specific gravity measurements for tapes made out of the dense (dry blend) of the C8 TPV pellets with the thermo-expandable microspheres over an extruder run period of 15 min was about 0.03, which is significantly higher than that of tapes made of foam pellets (E16), which was about 0.003. Accordingly, the foam articles (e.g., tapes) formed from the foam pellets of the present disclosure (having already incorporated thermo-expandable microspheres) are comparatively, and advantageously, more consistent in their specific gravities, which theoretically will result in more consistent mechanical and physical properties. The results are shown in Table 9 below.

Table 9: Haake single screw tape extrusion conditions and corresponding tape specific gravity for experimental examples (T-E16) of the two-step method for forming the foam pellets described herein (containing EXPANCEL™ 980MB120) and comparative examples (T-C8) (i. e., using the foam pellets E16-1, E16-2, E16-3 and comparative sample C8 sample of Table 8) are provided in Table 9. T1-C8, T2-C8, and T3-C8 are tapes made out of dense TPV C8 pellets according to Tables 7 and 8 by dry blending 1.5 wt. % EXPANCEL™ 980MB120. T1-C8-RE, T2-C8-RE, T3-C8-RE are tapes made out of dense TPV C8 pellets that were re-extruded and pelletized (i.e., that were exposed to additional temperature profile), and thereafter dry blended with 1.5% wt. EXPANCEL™ 980 MB120.

TABLE 9

| Extruder | T1- | T2- | T3- | T1- | T2- | T3- | T1- | T2- |
|---|---|---|---|---|---|---|---|---|
| Condition | E16-1 | E16-1 | E16-1 | E16-2 | E16-2 | E16-2 | E16-3 | E16-3 |
| Barrel Zone 1 Temperature (° C.) | 160 | 170 | 180 | 180 | 170 | 160 | 160 | 170 |
| Barrel Zone 2 Temperature (° C.) | 180 | 190 | 200 | 200 | 190 | 180 | 181 | 190 |
| Barrel Zone 3 Temperature (° C.) | 190 | 200 | 210 | 210 | 200 | 190 | 190 | 200 |
| Die Zone Temperature (° C.) | 190 | 200 | 210 | 210 | 200 | 190 | 190 | 200 |
| Melt Temperature (° C.) | 174 | 180 | 190 | 191 | 183 | 170 | 174 | 182 |
| Screw Torque (N-m) | 23.3 | 2.2.2 | 20.6 | 23.4 | 26.2. | 31 | 30.4 | 26.7 |
| Screw Rotation Speed (rpm) | 49.9 | 49.9 | 49.9 | 49.9 | 49.9 | 49.9 | 49.9 | 49.9 |
| Head Pressure (psi) | 490 | 455 | 425 | 439 | 477 | 518 | 526 | 481 |
| Throughput (kg/hr) | 1.48 | 1.48 | 1.46 | 1.57 | 1.65 | 1.71 | 1.70 | 1.65 |
| Specific Energy Input | 0.082 | 0.078 | 0.074 | 0.078 | 0.083 | 0.094 | 0.093 | 0.084 |
| (SEI) (Kw-hr/kg) | | | | | | | | |
| Tape SG | 0.630 | 0.610 | 0.631 | 0.595 | 0.601 | 0.634 | 0.651 | 0.615 |
| Corresponding Pellet Density | 0.773 | 0.773 | 0.773 | 0.900 | 0.900 | 0.900 | 0.942 | 0.942 |
| From Table 8 (g/cm³) | | | | | | | | |
| Shore A Hardness | 60.2 | 54.5 | 44.3 | 50.5 | 57.5 | 62.5 | 63.6 | 60.7 |
| 100% Modulus (MPa) | 2.90 | 2.60 | 2.3 | 2.5 | 2.7 | 3.0 | 3.0 | 2.8 |
| Ultimate Tensile Strength (MPa) | 4.1 | 3.7 | 3.0 | 3.3 | 3.7 | 4.0 | 4.1 | 3.7 |
| % Ultimate Elongation (%) | 315 | 307 | 270 | 260 | 289 | 296 | 291 | 287 |
| % Tension Set (%) | 27.3 | 29.8 | 29.4 | 29.5 | 29.8 | 28.6 | 28.0 | 29.6 |
| % Compression Set (%) | 53 | 62 | 66 | 67 | 60 | 51 | 53 | 55 |

| Extruder | T3- | | | | T1- | T2- | T3- |
|---|---|---|---|---|---|---|---|
| Condition | E16-3 | T1-C8 | T2-C8 | T3-C8 | C8-RE | C8-RE | C8-RE |
| Barrel Zone 1 Temperature (° C.) | 180 | 160 | 170 | 180 | 180 | 170 | 160 |
| Barrel Zone 2 Temperature (° C.) | 200 | 180 | 190 | 200 | 199 | 190 | 180 |
| Barrel Zone 3 Temperature (° C.) | 210 | 190 | 200 | 210 | 210 | 200 | 190 |
| Die Zone Temperature (° C.) | 210 | 190 | 200 | 211 | 210 | 200 | 190 |
| Melt Temperature (° C.) | 191 | 171 | 182 | 191 | 190 | 179 | 175 |
| Screw Torque (N-m) | 21.8 | 17.6 | 15.7 | 14.2 | 16.5 | 17.7 | 20.8 |
| Screw Rotation Speed (rpm) | 49.9 | 49.9 | 49.9 | 49.9 | 49.9 | 49.9 | 49.9 |
| Head Pressure (psi) | 441 | 495 | 468 | 435 | 412 | 451 | 480 |
| Throughput (kg/hr) | 1.56 | 1.50 | 1.46 | 1.46 | 1.36 | 1.39 | 1.42 |
| Specific Energy Input | 0.073 | 0.061 | 0.055 | 0.051 | 0.063 | 0.067 | 0.076 |
| (SEI) (Kw-hr/kg) | | | | | | | |
| Tape SG | 0.595 | 0.713 | 0.643 | 0.663 | 0.653 | 0.610 | 0.640 |
| Corresponding Pellet Density | 0.942 | 0.950 | 0.950 | 0.950 | 0.950 | 0.950 | 0.950 |
| From Table 8 (g/cm³) | | | | | | | |
| Shore A Hardness | 52.2 | 65.7 | 60.9 | 61.6 | 49.6 | 55.5 | 59.2 |
| 100% Modulus (MPa) | 2.6 | 3.5 | 3.1 | 3.2 | 2.9 | 2.9 | 3.0 |
| Ultimate Tensile Strength (MPa) | 3.5 | 5.0 | 4.4 | 4.8 | 4.1 | 4.1 | 4.3 |
| % Ultimate Elongation (%) | 271 | 326 | 327 | 346 | 308 | 310 | 303 |
| % Tension Set (%) | 29.0 | 25.8 | 31.2 | 29.4 | 28.5 | 28.3 | 28.1 |
| % Compression Set (%) | 64 | 58 | 64 | 61 | 59 | 66 | 61 |

Table 9 depicts that the SG and mechanical properties of experimental tapes made on the Haake single screw extruder from the experimental foam pellets E16-1, E16-2 and E16-3 are overall similar to those of comparative tapes made with the comparative pellets C8 and C8-RE, processed with identical Haake tape extrusion conditions. However, the experimental foam pellets E16-1, E16-2, and E16-3 already include thermo-expandable microspheres; therefore, foam articles (e.g., as represented by the tapes herein) can advantageously be produced by directly using the inventive foam pellets described in the present disclosure, without the complexity of adding any thermo-expandable microcapsules during extrusion of the foam article, while maintaining desired foam mechanical properties. Without being bound by theory, it is believed that the inclusion of the thermo-expandable microcapsules in the foam pellets results in better dispersion of the microspheres in the resultant foam article, as demonstrated by an order of magnitude less variability in SG in the foam article (SG standard deviation on the order of 0.003 for tapes made from foam pellets E16-1, E16-2, and E16-3 vs. SG standard deviation for tapes made from comparative pellets C8 and C8-RE).

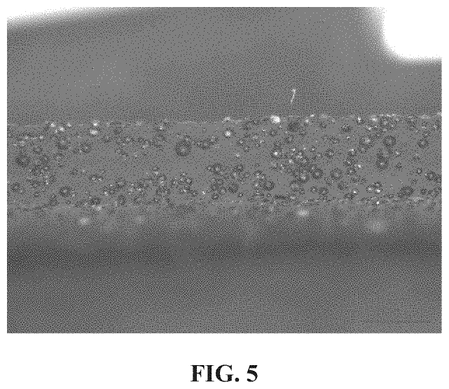

FIG. 4 depicts an optical microscopy image of a cross-sectional area of the foam tape T2-E16-3, showing the thermo-expandable microspheres therein, which are considerably expanded (e.g., decreased density) as compared to the E16-3 foam pellet (FIG. 3). As a comparison, FIG. 5 depicts an optical microscopy image of a cross-sectional area of comparative example T2-C8.

### Example 4—Two-Step Manufacturing Using 45 mm Single Screw Extruder

The two-step method for forming the foam pellets of the present disclosure using the Haake single screw extruder described above was repeated using a KME 45XS 45 mm single screw extruder (available from KraussMaffei Group GmbH, Brighton, Mich.). The KME 45 mm extruder is larger and demonstrates the commercial viability of the embodiments of the present disclosure. The 45 mm single screw extruder had an L/D of 32 with a barrier screw and a Spiral Maddock mixing section. A die width of 45 mm and thickness of 2.3 was used. The TPV dense pellets (not containing any thermo-expandable microcapsules) and the thermo-expandable microcapsules were dry blended and fed in the 45 mm single screw extruder hopper, similar to the procedure described for the Haake single extruder. The produced material in tape form was manually cut into shorter pieces of about 10 centimeters (cm) in length. Afterwards, the shorter pieces were fed into a J3/CJ5 re-grinding machine (available from Wittmann Battenfeld in Vienna. Austria) to produce small pieces referred to herein as “re-grinded pellets” (although no strand cut or underwater pelletizer was used) to enable them to be fed into the hopper of the 45 mm extruder to under-go subsequent extrusion to produce foam tapes. Accordingly, a “re-grinded foam pellet” represents the foam pellet compositions prepared according to the method of the present disclosure (E17) having included therein thermo-expandable microspheres. A screen mesh was used manually to remove dust from the small re-grinded pellets before feeding them to the 45 mm single screw extruder to make the foam tapes. Experimental sample E17 and comparative sample C9 (equivalent to C8 from Example 2) were used in this Example 4, and their compositions are provided in Table 10 below. Extruder conditions and density of the two-step method for forming the re-grinded foam pellets and comparative pellets are summarized in Table 11.

Table 10: Formulation of the two-step method experimental example foam pellet (E) and comparative example pellet (C) are provided in Table 10, where the second step is made with the 45 mm single extruder. For the first step of the two-step method, SANTOPRENE™ 161-80F260 was used and a thermo-microsphere formulation was examined. The compositions are expressed in wt. %, EXPANCEL™ 980MB120 is a master batch containing 65% by weight of the thermo-expandable microspheres 980DU120 in ethylene-vinyl-acetate (EVA) carrier polymer. Accordingly, the estimated amount of pure thermo-expandable microspheres in the foam pellet E17 below is 0.975 wt. % of the total formulation composition.

TABLE 10

| Ingredient | E17 | C9 |
|---|---|---|
| Santoprene ™ 161-80F260 Pellets | 98.5 | 100 |
| Expancel ™ 980MB120 MB Pellets | 1.5 | 0 |

Table 11: 45 mm single screw extruder process conditions for the two-step method for forming foam pellets (“re-grinded”) of the present disclosure and resultant pellets (“re-grinded”) are provided in Table 11. The formulations correspond to those depicted in Table 10.

TABLE 11

| Extruder Condition | E17-1 | E17-2 |
|---|---|---|
| Barrel Zone 1 Temperature (° C.) | 150 | 150 |
| Barrel Zone 2 Temperature (° C.) | 160 | 160 |
| Barrel Zone 3 Temperature (° C.) | 160 | 170 |
| Barrel Zone 4 Temperature (° C.) | 160 | 175 |
| Die Zone Temperature (° C.) | 160 | 170 |
| Melt Temperature (° C.) | 168 | 180 |
| Screw Rotation Speed (rpm) | 30 | 30 |
| Head Pressure (bar) | 65 | 28 |
| % Torque Load | 74 | 66 |
| Pellet SG | 0.943 | 0.887 |

As shown, each of the experimental samples have relatively high densities, which may be due to the lower processing temperatures (i.e., less than 185° C.) in the second extruder, as discussed above, which, in some instances, beneficially permits dense foam pellets to be prepared (i.e., dense while having thermo-expandable microspheres incorporated therein) that can thereafter be used to make foam articles where expansion occurs during the formation of the foam article.

The two-step method experimental foam pellets (E17-1 and E17-2) described in Table 11 were used to make tapes using a flat (rectangular) die on the 45 mm single screw extruder described above. As with the re-grinded pellets, a flat die with width of 45 mm and thickness of 2.3 mm was used to make the tapes. No screen pack was used in any of the experiments. The tapes exiting the die were deposited on a conveying belt and allowed to cool and crystallize at ambient temperature conditions. A 5 m tape sample was collected for each run condition. The specific gravity (SG) of 10 tape samples from the 5 m tape sample was measured for each condition and the average was reported. The results are shown in Table 12.

Table 12: 45 mm single screw tape extrusion conditions and corresponding tape specific gravity for experimental examples of the two-step method for forming the foam pellets containing EXPANCEL™ 980MB120 thermo-expandable microspheres (E17-2 and E17-2) made on 45 mm single screw extruder according to Tables 11 and 12. S1-E17-1, S2-E17-1, S3-E17-1, S1-E17-2, S2-E17-2, S3-E17-2 are made of foam pellet samples E17-1 and E17-2, compared to tapes made from C9 dense TPV pellets which were dry blended with 1.5 wt. % EXPANCEL™ 980MB120 on the 45 mm single screw extruder (S1-C9-EX, S2-C9-EX, and S3-C9-EX).

TABLE 12

| Extruder | S1- | S2- | S3- |
|---|---|---|---|
| Condition | C9-EX | C9-EX | C9-EX |
| Barrel Zone 1 Temperature (° C.) | 165 | 155 | 155 |
| Barrel Zone 2 Temperature (° C.) | 175 | 165 | 165 |
| Barrel Zone 3 Temperature (° C.) | 225 | 205 | 185 |
| Barrel Zone 4 Temperature (° C.) | 230 | 210 | 190 |
| Die Zone Temperature (° C.) | 225 | 205 | 185 |
| Melt Temperature (° C.) | 233 | 215 | 194 |
| Screw Rotation Speed (rpm) | 30 | 30 | 30 |
| Head Pressure (bar) | 14 | 15 | 17 |
| % Torque Load | 26 | 31 | 34 |
| Tape SG | 0.830 | 0.678 | 0.795 |
| Corresponding pellet SG From Table 11 | 0.950 | 0.950 | 0.950 |

| Extrader | S1- | S2- | S3- | S1- | S2- | S3- |
|---|---|---|---|---|---|---|
| Condition | E17-1 | E17-1 | E17-1 | E17-2 | E17-2 | E17-2 |
| Barrel Zone 1 Temperature (° C.) | 155 | 155 | 165 | 155 | 155 | 165 |
| Barrel Zone 2 Temperature (° C.) | 165 | 165 | 175 | 165 | 165 | 175 |
| Barrel Zone 3 Temperature (° C.) | 185 | 205 | 225 | 185 | 205 | 225 |
| Barrel Zone 4 Temperature (° C.) | 190 | 210 | 230 | 190 | 210 | 230 |
| Die Zone Temperature (° C.) | 185 | 205 | 225 | 185 | 205 | 225 |
| Melt Temperature (° C.) | 193 | 214 | 233 | 193 | 211 | 231 |
| Screw Rotation Speed (rpm) | 30 | 30 | 30 | 30 | 30 | 30 |
| Head Pressure (bar) | 18 | 16 | 15 | 22 | 20 | 17 |
| % Torque Load | 38 | 41 | 37 | 60 | 56 | 50 |
| Tape SG | 0.710 | 0.704 | 0.857 | 0.708 | 0.734 | 0.887 |
| Corresponding pellet SG From Table 11 | 0.943 | 0.943 | 0.943 | 0.887 | 0.887 | 0.887 |

### Example 5—Two-Step Manufacturing Using 50 mm Twin Screw Extruder

The two-step method for forming the foam pellets of the present disclosure using the Haake single screw extruder described above was repeated using a Nanjing Jieya 50 mm twin screw extruder (available from Nanjing Jieya Extrusion Equipment Co., Ltd., Lishui Country, NanJing). The Nanjing 50 mm extruder is larger than both the Haake and 45 mm single screw extrudes described in Examples 3 and 4 above, and additionally is a twin screw extruder (rather than a single screw extruder), further used to demonstrate the commercial viability of the embodiments of the present disclosure.

The 50 mm twin screw extruder had an L/D=40 with 9 heating (barrel) zones. The majority of the screw elements conveyed with two (2) kneading elements at Zones 2-3. Dense TPV pellets of SANTOPRENE™ 161-80F260 (i.e., pellets not containing any thermo-expandable microspheres) were fed into the 50 mm extruder hopper. Thermo-expandable microspheres EXPANCEL™ 980MB120 in master-batch pellet form were fed into a side feeder (NMRV050 worm reducer) (note that a powder feeder could also be used) with a conveying single screw located at a position of about 20 L/D from the extruder hopper. That is, the thermo-expandable microspheres were added later during the foam pellet formation in the second step of the two-step process, thereby potentially reducing extreme heat or prolonged exposure to the thermo-expandable microspheres. The 50 mm twin screw was connected to a strand cut pelletizer pelletize and produce the two-step method foam pellets of an embodiment of the instant disclosure. Experimental sample E21 and its composition are provided in Table 13 below. Extruder conditions and density of the two-step method for forming the foam pellets (E21) are summarized in Table 14. For comparison, comparative example C9 foam pellets and tapes of Example 3 may be referenced.

Table 13: Formulation of the two-step method experimental example foam pellets (E) are provided in Table 13, where the second step is made with a Nanjing Jieya 50 mm twin screw extruder. The compositions are expressed in wt. %. EXPANCEL™ 980MB120 is a master batch containing 65% by weight of the thermo-expandable microspheres 980DU120 in ethylene-vinyl-acetate (EVA) carrier polymer. Accordingly, the estimated amount of pure thermo-expandable microspheres in the foam pellet E21 below is 0.975 wt. % of the total formulation composition.

TABLE 13

| Ingredient | E21 |
|---|---|
| SANTOPRENE ™ 161-80F260 Pellets | 98.5 |
| EXPANCEL ™ 980MB120 MB Pellets | 1.5 |

Table 14: 50 mm twin screw extruder process conditions for the two-step method for forming foam pellets of the present disclosure, and corresponding pellet density for the experimental (E21) example, are provided in Table 14. The formulations correspond to that depicted in Table 13.

TABLE 14

| Extruder Condition | E21-1 |
|---|---|
| Barrel Zone 1 Temperature (° C.) | 170 |
| Barrel Zone 2 Temperature (° C.) | 175 |
| Barrel Zone 3 Temperature (° C.) | 170 |
| Barrel Zone 4 Temperature (° C.) | 165 |
| Barrel Zone 5 Temperature (° C.) | 163 |
| Barrel Zone 6 Temperature (° C.) | 158 |
| Barrel Zone 7 Temperature (° C.) | 158 |
| Barrel Zone 8 Temperature (° C.) | 158 |
| Barrel Zone 9 Temperature (° C.) | 158 |
| Die Zone Temperature (° C.) | 168 |
| Melt Temperature (° C.) | 170 |
| Extruder Screw Rotation Speed (rpm) | 60 |
| Side Feeder Screw Rotation Speed (rpm) | 40 |
| Total Throughput (kg/hr) | 40 |
| Side Feeder (Thermo-Expandable Microsphere | 10 |
| MB) Throughput (kg/hr) | |
| Head Pressure (MPa) | 5.5 |
| Current (Amps) | 56 |
| Pellet SG | 0.927 |

As shown, the E21 foam pellet exhibits a relatively high density, which may be due to the lower processing temperatures (i.e., less than 185° C.) in the second extruder, as discussed above, which, in some instances, beneficially permits dense foam pellets to be prepared (i.e., dense while having thermo-expandable microspheres incorporated therein) that can thereafter be used to make foam articles where expansion occurs during the formation of the foam article. Additionally, the high density may be due to the inclusion of the thermo-expandable microspheres in the second extruder at a later time during processing (e.g., towards the middle or end of the process).

The two-step method experimental foam pellets (E21-1) described in Table 14 were used to make tapes using a flat (rectangular) die on the KME 45XS 45 mm single screw extruder, as described above with reference to Example 4. A flat die with width of 45 mm and thickness of 2.3 mm was used to make the tapes. No screen pack was used in any of the experiments. The tapes exiting the die were deposited on a conveying belt and allowed to cool and crystallize at ambient temperature conditions. A 5 m tape sample was collected for each run condition. The specific gravity (SG) of 10 tape samples from the 5 m tape sample was measured for each condition and the average was reported. The results are shown in Table 15.

Table 15: 45 mm single screw tape extrusion conditions and corresponding tape specific gravity for an experimental example of the two-step method for forming the foam pellets containing EXPANCEL™ 980MB120 thermo-expandable microspheres (EE21-1) made on 50 mm single twin extruder according to Table 14. S1-E21-1, S2-E21-1, S3-E21-1, and S4-E21-1 are made of foam pellet sample E21-1.

TABLE 15

| Extruder Condition | S1-E21-1 | S2-E21-1 | S3-E21-1 | S4-E21-1 |
|---|---|---|---|---|
| Barrel Zone 1 Temperature (° C.) | 155 | 155 | 155 | 160 |
| Barrel Zone 2 Temperature (° C.) | 165 | 165 | 165 | 170 |
| Barrel Zone 3 Temperature (° C.) | 185 | 195 | 205 | 215 |
| Barrel Zone 4 Temperature (° C.) | 190 | 200 | 210 | 220 |
| Die Zone Temperature (° C.) | 185 | 195 | 205 | 215 |
| Melt Temperature (° C.) | 195 | 204 | 213 | 222 |
| Screw Rotation Speed (rpm) | 60 | 60 | 60 | 60 |
| Head Pressure (bar) | 23 | 22 | 21 | 20 |
| % Torque Load | 59 | 55 | 50 | 51 |
| Tape SG | 0.658 | 0.631 | 0.618 | 0.644 |
| Corresponding pellet SG From Table 15 | 0.927 | 0.927 | 0.927 | 0.927 |

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately α-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A foam pellet comprising a thermoplastic vulcanizate (TPV) and thermo-expandable microspheres, the foam pellet having a specific gravity of 0.1 to 1.0 and the TPV comprising an at least partially vulcanized rubber component and a thermoplastic component.

2. The foam pellet according to claim 1, wherein the pellet has a specific gravity of 0.5 to 0.95.

3. (canceled)

4. The foam pellet according to claim 1, wherein greater than 50% of the thermo-expandable microspheres have an un-ruptured shell.

5. The foam pellet according to claim 1, wherein the thermo-expandable microspheres are present in an amount of 0.5% to 10% by weight of the TPV.

6-8. (canceled)

9. The foam pellet according to claim 1, wherein the foam pellet does not comprise a thermoplastic modifier.

10. The foam pellet according to claim 1, wherein at least a portion of the thermo-expandable microspheres are unexpanded.

11. The foam pellet according to claim 1, wherein the at least partially vulcanized rubber is selected from the group consisting of an ethylene-propylene rubber; an ethylene-alpha olefin copolymer rubber; an ethylene-propylene-diene rubber; a natural rubber; a butyl rubber; a halobutyl rubber; a halogenated rubber copolymer of p-alkystyrene and at least one isomonoolefin having 4 to 7 carbon atoms; a copolymer of isobutylene and divinyl-benzene; a rubber homopolymer of a conjugated diene having from 4 to 8 carbon atoms; a rubber copolymer having at least 50 weight percent repeat units from at least one conjugated diene having from 4 to 8 carbon atoms and a vinyl aromatic monomer having from 8 to 12 carbon atoms, or acrylonitrile monomer, or an alkyl substituted acrylonitrile monomer having from 3 to 8 carbon atoms, or an unsaturated carboxylic acid monomer, or an unsaturated anhydride of a dicarboxylic acid; and the like; and any combination thereof.

12. The foam pellet according to claim 1, wherein the at least partially vulcanized rubber comprises ethylene-propylene-diene rubber.

13. The foam pellet according to claim 1, wherein the thermoplastic component is selected from the group consisting of a polymer prepared from olefin monomers having 2 to 7 carbon atoms, a copolymer prepared from olefin monomers having 2 to 7 carbon atoms with a (meth)acrylate or a vinyl acetate, and any combination thereof.

14. The foam pellet according to claim 1, wherein the thermoplastic component is selected from the group consisting of polyethylene, polypropylene, and any combination thereof.

15. A single-step method for preparation of a foam pellet according to claim 1 comprising:
introducing a rubber component to an extruder;
introducing a thermoplastic component to the extruder;
optionally, introducing at least one first additive to the extruder;
introducing a curing agent, and optionally an accelerator, into the extruder;
optionally, introducing at least one second additive to the extruder downstream of at least the curing agent;
dynamically vulcanizing the rubber component, thereby forming the at least a partially vulcanized rubber component in the presence of the thermoplastic component and curing agent, thereby forming the thermoplastic vulcanizate;
introducing the thermo-expandable microspheres to the extruder;
extruding a blend of the thermoplastic vulcanizate and thermo-expandable microspheres through a die; and
pelletizing the extruded blend, thereby forming the foam pellet.

16. The method according to claim 15, wherein the at least one first additive is one or more of an additive oil and a particulate filler.

17. The method according to claim 15, wherein the at least one second additive is an additive oil.

18. The method according to claim 15, wherein at least one first additive is introduced to the extruder, and the at least one first additive is introduced upstream of the curing agent.

19. The method according to claim 15, wherein the thermo-expandable microspheres are introduced to the extruder downstream of the curing agent.

20. The method according to claim 15, wherein the thermo-expandable microspheres are introduced to the extruder upstream of the curing agent.

21. The method according to claim 15, wherein the thermo-expandable microspheres are introduced to the extruder simultaneously with the curing agent.

22. The method according to claim 15, wherein the accelerator is introduced to the extruder.

23. The method according to claim 15, wherein the extruder is a single screw extruder or a twin screw extruder.

24. The method according to claim 15, wherein the thermo-expandable microspheres are dispersed in oil.

25. The method according to claim 24, wherein thermo-expandable microspheres dispersed in oil are introduced to the extruder by injection.

26. The method according to claim 15, wherein the thermo-expandable microspheres are introduced to the extruder in solid form.

27. The method according to claim 15, wherein the thermo-expandable microspheres are introduced to the extruder by crammer side feeder or a hopper of the extruder.

28. The method according to claim 15, wherein the curing agent is selected from the group consisting of a phenolic compound, a peroxide, a metal oxide, a maleimide, a sulfur-based curative, a silicon-based curative, a silane-based curative, a metal ligand complex, and any combination thereof.

29. The method according to claim 15, wherein the thermo-expandable microspheres are introduced prior to the dynamic vulcanization.

30-56. (canceled)
